(19) United States
(12) Patent Application Publication
(10) Pub. No.: US 2017/0244344 A1
(43) Pub. Date: Aug. 24, 2017

(54) ENERGY-EFFICIENT MOTOR DRIVE WITH OR WITHOUT OPEN-CIRCUITED PHASE

(71) Applicant: CANADIAN SPACE AGENCY, Saint-Hubert (CA)

(72) Inventor: Farhad AGHILI, Brossard (CA)

(21) Appl. No.: 15/440,231

(22) Filed: Feb. 23, 2017

Related U.S. Application Data
(60) Provisional application No. 62/298,730, filed on Feb. 23, 2016.

(51) Int. Cl. H02P 6/15; H02P 6/12

(52) U.S. Cl. CPC H02P 6/15; H02P 6/12

(57) ABSTRACT

An energy-efficient and accurate torque control system and method for multiphase nonsinusoidal PMSM with or without open-circuited phase(s) under time-varying torque and speed conditions is based on orthogonally decomposing a phase voltage vector into two components, which become primary and secondary control inputs for torque control and energy minimizer control. The primary control system includes nonlinear feedback from measured phase currents, motor angle, motor speed, and instantaneous value of reference torque and a signature vector indicating which phase(s) is/are open-circuited to establish a first-order linear relationship between reference and generated torques. The secondary control system includes an estimator to estimate a system costate from measured phase currents, motor angle, motor speed, and instantaneous value of reference torque and the signature vector and a linear programming module with equality/inequality constraints to calculate the secondary voltage input to optimally align the overall phase voltage for maximum efficiency without saturating the inverter voltage.

### CROSS REFERENCE TO RELATED APPLICATION

This application claims the benefit of U.S. Provisional Application No. 62/298,730 filed on Feb. 23, 2016, which is incorporated by reference.

### TECHNICAL FIELD

The present invention relates generally to electric motors and, more particularly, to the control of permanent-magnet synchronous machines.

### BACKGROUND

Permanent-magnet synchronous machines (PMSMs) are commonly used for high-performance and high-efficiency motor drives in a huge range of applications: from silicon wafer manufacturers, robotics, industrial automation, machine tools, and electric vehicles to aerospace and military. Precise and fast torque tracking or torque regulation performance over the entire speed/torque range of the machine is highly required in some of these applications [1], whereas energy-efficiency or fault tolerance becomes important in the others [2,3]. (For the purposes of this specification, the notation in brackets refers to the publications and references whose complete citations are listed on page 37.) The underlying torque control schemes are usually adopted based on the way the machine's windings are constructed to produce sinusoidal or nonsinusoidal flux density in the airgap. Nevertheless, in either cases, the machine torque can be controlled either directly by controlling the PWM voltage of phases or indirectly by controlling the phase currents using internal current feedback loop [4-14].

Park's transformation, also known as d-q transform, is the cornerstone of direct torque control of 3-phase sinusoidal PMSMs. This physically intuitive technique simplifies the control calculations of balanced three-phase motors and has been used for development of a variety of classical nonlinear control laws to sinusoidal PMSMs. Although this formulation leads to perfect voltage-torque linearization of sinusoidal electric machines, some researchers attempted to extend the Park's transformation for particular kinds of electric machines with nonsinusoidal flux distribution [14,15]. Field-oriented control (FOC), also known as vector control, is the most popular direct control technique for 3-phase sinusoidal PMSMs that allows separate control of the magnetic flux and the torque through elegant decomposition of the field generating part and torque generating part of the stator current. Nevertheless, there are other direct control possibilities such as state feedback linearization [16-18] or direct torque control (DTC) [19-23]. The DTC schemes have been further developed to minimize copper loss or to defer voltage saturation using flux-weakening control in order to extend the range of operational speed of sinusoidal PMSMs [24-27].

A nonlinear optimal speed controller based on a state-dependent Riccati equation for PMSMs with sinusoidal flux distribution was presented in [28]. It is also shown in [29] that in the presence of a significant time delay in the closed loop, a feedback linearization control technique cannot yield exact linearization of the dynamics of electric motors but a residual term depending on incremental position remains in the closed-loop dynamics. The motor torque control problem is radically simplified in the indirect approach, in which internal current feedback loops impose sinusoidal current repartition dictated by an electronically controlled commutator [30, 31]. Ideal 3-phase sinusoidal PMSMs perform optimally when simply driven by sinusoidal commutation waveforms. However, the shortcoming of this approach is that the phase lag introduced by the current controller may lead to pulsation torque at high velocity unless a large bandwidth controller is used to minimize the phase shift [32, 33]. The performance of the indirect torque controller is satisfactory only if the significant harmonics of current commands are well below the bandwidth of the closed-loop current controller, e.g., less than one-tenth.

Applications of the above controllers to unideal PMSMs in the presence of harmonics in their flux density distribution will result in torque pulsation. Although several motor design techniques exist that can be used in development of the stator or rotor of PMSMs to minimize the back-EMF harmonics [34, 35], such machines tend to be costly and offer relatively low torque/mass capacity [34, 36]. Therefore, advanced control techniques capable of reducing residual torque ripples are considered for unideal PMSMs for high performance applications [36]. Direct torque control is proposed for nonsinusoidal brushless DC motors using Park-like transformation [15]. The controller achieves minimization of copper losses but only for torque regulation, i.e., constant torque, plus voltage saturation limit is not taken into account. Various optimal or non-optimal indirect torque control of unideal PMSMs by taking into account the presence of harmonics in the back-EMF [37]. Various techniques are presented in [7, 38, 39] for torque-ripple minimization of nonsinusoidal PMSMs by making use of individual harmonics of the back-EMF to obtain stator currents. Optimal-current determination for multiphase nonsinusoidal PMSMs in real time are reported in [7, 9]. Since these indirect optimal torque control schemes do not take dynamics of the current feedback loop into account, either a large bandwidth current controller or sufficiently low operational speed range are the required conditions in order to be able to inject currents into the inductive windings without introducing significant phase lag for smooth torque production.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In general, and by way of overview, the embodiments of the present invention disclosed herein provide an energy-efficient and fault-tolerant torque control system and method for the control of multiphase nonsinusoidal PMSMs to thereby enable accurate torque production over substantially the entire operational speed/torque range. An optimal feedback linearization torque controller is disclosed herein that is capable of producing ripple-free torque while maximizing machine efficiency subject to maintaining phase voltages below the voltage saturation limit. The optimal control problem is cast in terms of the maximum principle formulation and subsequently a closed form solution is analytically obtained making the controller suitable for real-time implementation. Some important features of the optimal controller are: i) the control solution is applicable for general PMSMs with any number of phases or back-EMF waveforms; ii) the optimal control solution is valid for time-varying torque or variable-speed drive applications such as robotics or electric vehicles. Furthermore, the torque controller can recover from a fault due to open-circuited phase(s) and therefore can achieve voltage-to-torque linearization even for a faulty motor. For completeness, an indirect torque controller is also disclosed herein that solves the shortcoming of the conventional controller of this kind relating to the phase lag introduced by the internal current feedback loop that can lead to significant torque ripples at high speed. This is made possible by incorporating a current loop dynamics model in the electrically controlled commutator, which converts the desired torque into the required stator phase currents according to operating speed.

Accordingly, one inventive aspect of the disclosure is a controller for controlling a multi-phase permanent magnet synchronous motor. The controller includes a feedback linearization control module for generating a primary control voltage and an energy minimizer for generating a secondary control voltage, wherein the feedback linearization control module is decoupled from the energy minimizer such that the energy minimizer does not affect the feedback linearization control module.

Another inventive aspect of the disclosure is a method of controlling a multi-phase permanent magnet synchronous motor. The method entails generating a primary control voltage using a feedback linearization control module and generating a secondary control voltage using an energy minimizer wherein the feedback linearization control module is decoupled from the energy minimizer such that the energy minimizer does not affect the feedback linearization control module.

Yet another inventive aspect of the disclosure is a fault-tolerant, energy-efficient motor system that includes a multi-phase permanent magnet synchronous motor and a controller for controlling the motor. The controller includes a feedback linearization control module for generating a primary control voltage and an energy minimizer for generating a secondary control voltage, wherein the feedback linearization control module is decoupled from the energy minimizer such that the energy minimizer does not affect the feedback linearization control module.

Still another inventive aspect of the disclosure is a controller for controlling a salient-pole synchronous motor, the controller comprising:
a voltage computational module for computing a dq voltage based at least on shaft position and speed, and phase currents;
an energy minimizer module for computing an energy minimizing control input z; and
a voltage computational module for computing a dq voltage based in part on a torque component and said energy minimizing control input z.

### BRIEF DESCRIPTION OF DRAWINGS

These and other features of the disclosure will become more apparent from the description in which reference is made to the following appended drawings.

FIG. 1 is a block diagram of a composite linearization/optimal controller.

FIG. 2 is a circuit diagram of an energy-efficient motor controller in accordance with an embodiment of the present invention.

FIG. 3 depicts a dynamometer test setup.

FIG. 4 is a graph showing per-phase motor torque as a function of the mechanical angle.

FIG. 5 is a graph of torque as a function of time.

FIG. 6 presents two graphs of phase voltage and current as a function of time for a motor operating without the energy-efficient motor control feedback.

FIG. 7 presents two graphs of phase voltage and current as a function of time for a motor operating with the energy-efficient motor control feedback.

FIG. 8A is a graph of power dissipation for a motor operating without the optimal controller.

FIG. 8B is a graph of power dissipation for a motor operating with the optimal controller.

FIG. 9 is a graph comparing energy losses for a motor operating with and without the optimal controller.

FIG. 10 is a graph presenting experimental torque tracking performance of a motor during a transition from a normal operating condition to a single-phase faulty condition (in which phase 3 is open-circuited).

FIG. 11A is a graph showing fluctuations in motor voltage during the transition from the normal operating condition to the single-phase faulty condition (in which phase 3 is open-circuited).

FIG. 11B is a graph showing fluctuations in motor current during the transition from the normal operating condition to the single-phase faulty condition (in which phase 3 is open-circuited).

FIG. 12 is a flowchart presenting a method of controlling a motor.

FIG. 13 is a schematic representation of another embodiment.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

In general, the embodiments disclosed in this specification provide an energy-efficient control system and method of controlling a permanent magnet synchronous machine.

### 1. Modelling of Multiphase Nonsinusoidal PMSMs Using Projection Matrix and Fourier Series

A general PMSM with p phases and q pole pairs has current and voltage vectors denoted, respectively i=[i₁, . . . , iₚ]^{T} and v=[v₁, . . . , vₚ]^{T}. According to the Faraday's Law and Ohm's Law, the voltage across terminals can be described by

$$v = L \frac{di}{dt} + Ri + λ ( θ ) ω \qquad ( 1 )$$

where θ is the rotor angular position, ω is the angular velocity, λ is the partial derivative of total flux linkage with respect to the angular position, R is the coil resistance, and L is the inductance matrix. The inductance matrix can be constructed in terms of the self-inductance, Lₛ, and mutual-inductance, Mₛ, of the stator coils as follows

L=(Lₛ−Mₛ)I+MₛJ (2)

where I is the identity matrix, and J=11^{T} is the matrix of one with 1=[1,1, . . . , 1]. The inverse of the inductance matrix (2) takes the form

$${L}^{- 1} = \frac{1}{{L}_{s} - {M}_{s}} D , where D = I - α J \qquad ( 3 )$$

and the dimensionless scalar α is given by

$$α = \frac{{M}_{s}}{( p - 1 ) {M}_{s} + {L}_{s}} . \qquad ( 4 )$$

The sum of phase currents is defined by

iₒ=1^{T}i (5)

Then, the voltage equation (1) can be equivalently rewritten by the following differential equations

$$μ \frac{di}{dt} + i - α {i}_{0} 1 = \frac{1}{R } D ( v - ω λ ) \\ {μ}_{0} \frac{{di}_{0}}{dt} + {i}_{0} = \frac{1}{R} {1}^{T} ( v - ω λ ) \\ where \\ μ = \frac{{L}_{s} - {M}_{s}}{R} and {μ}_{o} = \frac{{L}_{s} + ( p - 1 ) {M}_{s}}{R} \qquad ( 6 )$$

are the machine time-constants. For star-connected machines with no neutral point line, i.e., balanced phase motor, the following constraint must be imposed on the phase currents

iₒ=1^{T}i=0 (7)

The following projection matrix P is defined:

$$P = \frac{1}{p} [ \begin{matrix}p - 1 & - 1 & … & - 1 \\ - 1 & p - 1 & … & - 1 \\ … & … & … & … \\ - 1 & - 1 & … & p - 1\end{matrix} ] \qquad ( 8 )$$

which removes the mean-value (average) of any vector x ε R^{p}, i.e., i=Pi .

It appears from (6) that the current constraint can be maintained if the following constraint at the voltage level is respected

1^{T}(v−λω)=0 (9)

Identity (9) implies exponential stability of the internal state iₒ, i.e., iₒ=iₒ(0)e^{-μ}^{ₒ}^{t}. In this case, the iₒ term in (6) vanishes and therefore the dynamic equation of PM synchronous motors with no neutral point line is simplified as follows

$$μ \frac{di}{dt} + i = \frac{1}{R} P ( v - λ ω ) \qquad ( 10 )$$

which is obtained by using the following property

DP=P (11)

On the other hand, the electromagnetic torque τ produced by an electric motor is the result of converting electrical energy to mechanical energy, and hence it can be found from the principle of virtual work [40]

τ=λ^{T}i=λ′^{T}i (12)

where vector λ′=Pλ is the projected version of λ.

Equations (10) and (12) completely represent the parametric modeling of a multiphase nonsinusoidal PMSM in terms of function λ(θ). For an ideal synchronous machine, λ(θ) is a sinusoidal function of rotor angle. In general, however, λ(θ) is a periodic function with spatial frequency 2π/q. Therefore, it can be effectively approximated through the truncated complex Fourier series

$${λ}_{k} ( θ ) = {\sum }_{m = - N}^{N} {a}_{m} {ϕ}_{mk} {e}^{j m q θ} \\ ∀ k = 1 , … , p \qquad ( 13 )$$

where j=\sqrt{−1}, aₘs are the corresponding Fourier coefficients, N can be chosen arbitrarily large, and phase shift

φₘₖ=e^{2jτan(k-1)/p} (14)

is denoted as such because successive phase windings are shifted by 2π/p. Notice that λₖ(θ) is a real valued function and hence its negative Fourier coefficients are the conjugate of the corresponding positive ones, that is a₋ₘ=āₘ where the bar sign denotes the conjugate of a complex number. Furthermore, since the magnetic force is a conservative field for linear magnetic systems, the average torque over a period must be zero, and thus a₀=0. By the virtue of the projection matrix, the expression of λ′ₖ can be written as

$$\begin{matrix}{λ}_{k}^{′} ( θ ) = {\sum }_{m = - N}^{N} {a}_{m} {ϕ}_{mk} {e}^{jmq θ} \\ = - \frac{1}{p} {\sum }_{m = - N}^{N} {\sum }_{k = 1}^{p} {a}_{m} {e}^{2 j π m ( k - 1 ) / p} {e}^{jmq θ}\end{matrix} \qquad ( 15 )$$

where the whole second term in the right hand side of (15) is the vector average. From the following identity

$${\sum }_{k = 1}^{p} {e}^{2 j π m ( k - 1 ) / p} = \{ \begin{matrix}p & if m = \pm p , \pm 2 p , \pm 3 p , … \\ 0 & otherwise\end{matrix} \qquad ( 16 )$$

one can show that the expression in the right side hand of (16) vanishes when m is not a multiple of p. Thus

$${λ}_{k}^{′} ( θ ) = {\sum }_{{m = - N}_{m ∉ P}}^{N} {a}_{m} {ϕ}_{mk} {e}^{jmq θ} \qquad ( 17 )$$

where P={±p,±2p,±3p, . . . }.

Since the trivial zeros of the Fourier coefficients occur at those harmonics which are multiples of p, one can define vector a containing only the nontrivial-zero Fourier coefficients where N′=[N(p−1)/p].

The time-derivative of the torque expression (12) yields

$$\dot{τ} = {λ}^{′ T} \frac{di}{dt} + {i}^{T} \frac{\partial λ}{\partial θ} ω \qquad ( 18 )$$

Using the expression of the time-derivative of phase currents from (10) in (18) gives

$$τ + μ \dot{τ} = \frac{1}{R} {λ}^{′ T} v - \frac{1}{R} {‖ {λ}^{′} ‖}^{2} ω + μ ω {i}^{T} {λ}_{θ} \\ where \\ {λ}_{θ} = \frac{\partial λ}{\partial θ} \qquad ( 19 )$$

Here, the k-th elements of vector λ_{θ} can be calculated from the following Fourier series

$${λ}_{{θ}_{k}} ( θ ) = {\sum }_{{m = - N}_{m ∉ P}}^{N} {a}_{m}^{′} {ϕ}_{mk} {e}^{jmq θ}$$

where a′ₘ=jmqaₘ. Differential equation (19) describes explicitly the torque-voltage relationship of multiphase nonsinusoidal PMSMs that provides the basis for the control system and method. Equation (19) reveals that the voltage component perpendicular to vector λ′ does not contribute to the torque production. Therefore, we define the primary control input vₚ and secondary control input v_{q} from orthogonal decomposition of voltage vector

v=vₚ⊕v_{q} (20)

such that the secondary control input satisfies

λ′^{T}v_{q}=0 (21)

Here, the primary control input will be determined first to control the motor torque whereas the secondary control input, which does not affect the motor torque, will be subsequently utilized to maximize the motor efficiency.

The primary control input vₚ receives a main control signal that controls the electromagnetic torque whereas the secondary control input v_{q} is utilized to minimize power dissipation for achieving maximum machine efficiency and, at the same time, to defer phase voltage saturation for enhancing the operational speed.

### 2. Optimal Feedback Linearization Torque Control

### 2.1 Linearization Control Input

Assume that the primary control input is dictated by the following control law

vₚ=λω+R(u−μωi^{T}λ₀(θ)η(θ)) (22)

where η(θ)=[η₁(θ), . . . ηₚ(θ)]^{T} ε C^{P} and u is an auxiliary control input. Knowing that λ′^{T}λ=∥λ′∥² and substituting the control law (22) into the motor torque equation (19) yields the differential equation of the closed-loop torque system

τ+μ\dot{τ}=μωi^{T}λ_{θ}+(u−ωμi^{T}λ_{θ}(θ))λ′^{T}(θ)η(θ)

The above expression is drastically simplified to the following first-order linear differential equation

τ+μ\dot{τ}=u (23)

only if the following identity is held

λ′^{T}(θ)η(θ)=1 ∀ θ ε R (24)

There is more than one solution to (24), but the minimum norm solution is given by

$$η ( θ ) = \frac{{λ}^{′} ( θ )}{{‖ {λ}^{′} ‖}^{2}} ← min ‖ η ‖ \qquad ( 25 )$$

Finally substituting function η(θ) from (25) into (22) yields an explicit expression of the feedback linearization control law of multiphase nonsinusoidal synchronous machines

$${v}_{p} = λ ω + R ( u - μ ω {i}^{T} {λ}_{θ} ) \frac{{λ}^{′}}{{‖ {λ}^{′} ‖}^{2}} \qquad ( 26 )$$

Equation (26) satisfies the voltage constraint (9) and therefore applying the voltage control to a star-connected machine will result in zero current at the neutral line. In other words, (26) determines the primary control input to achieve torque control of balanced motors.

### 2.2 Optimal Control Input

The feedback linearizing control (26) takes neither minimization of copper losses nor saturation of terminal voltage into account. On the other hand, these are important issues as minimization of the power dissipation could lead to enhancement of machine's efficiency and continuous torque capability. Moreover, an increasing rotor speed gives rise to a back-EMF portion of the terminal voltage, which should remain within the output voltage limit of the inverter. In the maximum speed limit when instantaneous voltage saturation occurs, the duty ratio of the inverter PWM control reaches 100%, then the inverter cannot inject more current at some instances and that will result in torque ripples. To extend the operating speed range of PMSMs, it is possible to shift the burden from the saturated phase(s) to the remaining phases in such a way as to maintain smooth torque production. To this end, the output voltage limit of the inverter vmax is imposed in the optimal control design, i.e.,

−vₘₐₓ1≦v≦vₘₐₓ1 (27)

In the following development, an optimal control input v_{q} complement is sought to minimize power dissipation while maintaining the overall voltage limit (27). Since v_{q} does not contribute to the torque production, the linearization outcome (23) will be unaffected by adding the voltage complement v_{q} to vₚ. Clearly, vector v_{q} should be with zero average, i.e.,

1^{T}v_{q}=0 or Pv_{q}=v_{q} (28)

so that the overall voltage constraint can be still maintained. Constrants (21) and (28) can be combined into the following identity

[1 λ′]^{T}v_{q}=0,

which constitutes the consistency condition for the secondary voltage control vector of balanced motors.

Substituting the linearization control law (26) into the machine voltage equation (10) and then using identity (28) yields the following time-varying linear system describing the current dynamics in response to the optimal input v_{q}

$$μ \frac{di}{dt} + ( I + μ ω Λ ) i = \frac{u ( t )}{{‖ {λ}^{′} ‖}^{2}} {λ}^{′} + \frac{1}{R} {v}_{q} \qquad ( 29 )$$

where matrix Λ is defined as

$$Λ = \frac{{λλ}_{θ}^{T}}{{‖ {λ}^{′} ‖}^{2}}$$

Assuming that the copper loss is the main source of power dissipation, then minimizing the copper loss is tantamount to maximizing machine efficiency. The cost function to minimize is the copper loss over interval h, i.e.,

$$J = {\int }_{t}^{T} {‖ i ( ϛ ) ‖}^{2} d ϛ \qquad ( 30 )$$

where T=t+h is the terminal time of the system. We can now treat vₚ as a known variable which permits determination of the lower bound and upper bound of the optimal control input, i.e.,

v_{lb}≦v_{q}≦v_{ub} (31a)

where

v_{lb}≦−vₚ−1vₘₐₓ

v_{ub}≦−vₚ+1vₘₐₓ (31b)

are the corresponding bounds. In summary, the equality constraints (21) and (28) together with inequalities (31a) represent the set of all permissible optimal controls, v_{q} εV.

The optimal control problem may now be formulated based on the maximum principle from equations (29) and (30) in conjunction with the constraint for permissible optimal controls represented by set [symbol] . To obtain an analytical solution for the optimal control v_{q}, it is supposed that p is the vector of costate variables (“costate vector” or “costate”) of the same dimension as the state vector i. Then, the Hamiltonian function can be constructed from (29) and (30) as

$$\begin{matrix}H = {p}_{o} {‖ i ‖}^{2} + {p}^{T} \frac{di}{dt} \\ = {p}_{o} {‖ i ‖}^{2} - {p}^{T} ( \frac{1}{μ} I + ωΛ ) i + \frac{u ( t )}{μ {‖ {λ}^{′} ‖}^{2}} {p}^{T} {λ}^{′} + \frac{1}{μ R} {p}^{T} {v}_{q}\end{matrix} \qquad ( 32 )$$

Clearly p₀>0 is a constant scalar for normalization of the Hamiltonian that can be arbitrarily selected as multiplying the cost function by any positive number will not change the optimization outcome. The optimality condition stipulates that the time-derivative of the costate vector satisfies

$$\dot{p} = - \frac{\partial H}{\partial i} \qquad ( 33 )$$

Therefore, the evolution of the costate is governed by the following time-varying differential equation

$$\dot{p} = ( \frac{1}{2} I + {ωΛ}^{T} ) p - 2 {p}_{o} i \qquad ( 34 )$$

and the transversal condition dictates

p(T)=0. (35)

From the identities PΛ^{T}=Λ^{T} and Pi=i and the boundary condition (35), one can infer that trajectories of the costate must also satisfy

Pp=p or 1^{T}p=0 (36)

meaning that the costate is indeed a zero-average vector.

The equivalent discrete-time model of the continuous system (34) can be derived via Euler's method

$$\frac{1}{h} ( {p}_{k + 1} - {p}_{k} ) = ( \frac{1}{μ} I + {ω}_{k} {Λ}_{k}^{T} ) - 2 {p}_{o} {i}_{k} \qquad ( 37 )$$

Using the boundary condition pₖ₊₁=0 in (37) and rearranging the resultant equation, one can show that the values of the state and the costate are relate to each other at epoch tₖ through the following matrix equation

p*ₖ=(I+σωₖΛₖ^{T})⁻¹iₖ

where scalar σ is defined by

$$σ = \frac{h}{h + μ} \qquad ( 39 )$$

and pₒ=1/(2σμ) is selected for simplicity of the resultant equation. Notice that computation of the costate from (38) does not involve its time-history. Therefore, for the sake of notational simplicity, we will drop the k subscript of the variables in the following analysis without causing ambiguity. It is worth noting that for sufficiently small σ, i.e.,

σμ<<|ω|max∥Λ∥ (40)

the inverse matrix in the RHS of (38) can be effectively approximated by I−σωΛ^{T}. Therefore the optimal trajectories of the costate vector can be computed from

p≈(I−σωΛ^{T})i

which is numerically preferred because the latter equation does not involve matrix inversion.

According to the Pontryagin's minimum principle, the optimal control input minimizes the Hamiltonian over the set of all permissible controls and over optimal trajectories of the state i* and costate p*, i.e.,

$${v}_{q} = arg {min}_{{v}_{q} ∈ V} H ( {i}^{*} , {p}^{*} , {v}_{q} , t ) \qquad ( 41 )$$

It can be inferred from the expression of Hamiltonian (32) and identity (11) that (41) is tantamount to minimizing p^{T}v_{q} subject to the equality and inequality constraints of admissible v_{q}. Another projection matrix may be defined

$$Q = I - \frac{{λ}^{′} {λ}^{′ T}}{{‖ {λ}^{′} ‖}^{2}} \qquad ( 42 )$$

which project vector from R^{P} to a vector space perpendicular to λ′, i.e., v_{q}=Qv_{q}. Subsequently, suppose directional vector k is defined as the component of costate vector which is perpendicular to λ′. Then, k can be readily obtained from the newly defined projection matrix

k=Qp* (43)

One can verify that k is indeed a zero-average vector because (43) satisfies 1^{T}k=0. Therefore, if the voltage limit constraint is ignored, then the problem of finding optimal v_{q} minimizing the Hamiltonian can be equivalently written as

$${v}_{q} = arg {min}_{{v}_{q}} {k}^{T} {v}_{q} \qquad ( 44 )$$

It appears from (44) that an optimal control input v_{q} should be aligned with vector k in an opposite direction. That is

v_{q}=−γk (45)

where γ>0 can be selected as large as possible but not larger than what leads to saturation of the terminal voltage vₘₐₓ. Equation (45) automatically satisfies the condition 1^{T}k=0 and therefore (45) gives a permissible solution. Alternatively, the problem of finding optimal permissible v_{q} satisfying the voltage limit can be transcribed to the following constrained linear programming

$$\begin{matrix}minimum & {p}^{{}^{*} T} {v}_{q} \\ subject to & {[ \begin{matrix}1 & {λ}^{′}\end{matrix} ]}^{T} {v}_{q} = 0 \\ & {v}_{lb} \leq {v}_{q} \leq {v}_{ub}\end{matrix} \qquad ( 46 )$$

where values of v_{lb} and v_{ub} are obtained from instantaneous value of the linearization control input vₚ according to (31b). Solution to (46) gives the secondary control voltage for energy minimizing control of balanced motors.

### 2.2.1 Composite Linearization/Optimal Control

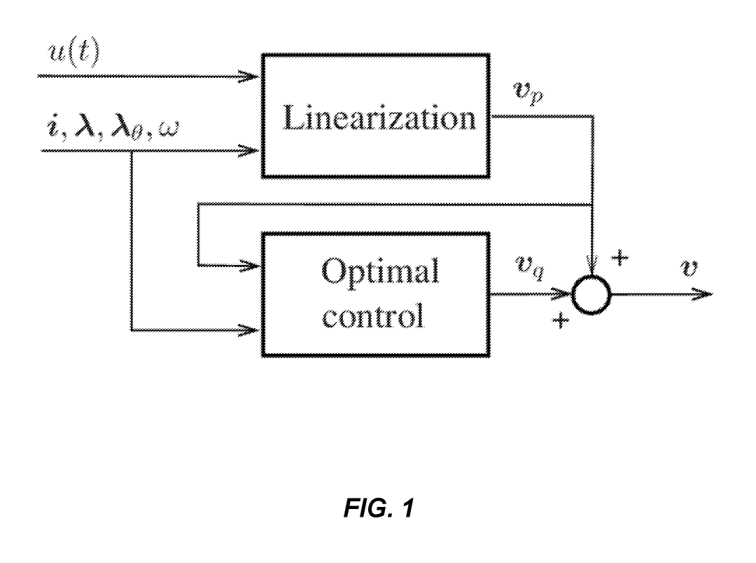

FIG. 1 illustrates the composite optimal-linearization torque controller. The linearization control vₚ is computed based on auxiliary input u(t) and the full state vector according to (26), while the optimizing control v_{q} is computed from the values of the linearization control voltage and the state vector according to either (45) or (46). The input/output of the linearized system in the Laplace domain is simply given by

$$\frac{τ ( s )}{u ( s )} = \frac{1}{μ s + 1} \qquad ( 47 )$$

where s is the Laplace variable and recall that μ is the machine time-constant. Since the linearized system (47) is strictly stable, the feedback linearization control scheme is inherently robust without recurring to external torque feedback loop. Nevertheless, in order to increase the bandwidth of the linearized system, one may consider the following PI feedback loop closed around the linearized system

u=K(s)(τ−τ*)=K(s)(λ′^{T}i−τ*)

where τ* is the desired input torque and K(s) represents the transfer function of the PI filter as

$$K ( s ) = {k}_{p} + {k}_{i} \frac{1}{s} \qquad ( 48 )$$

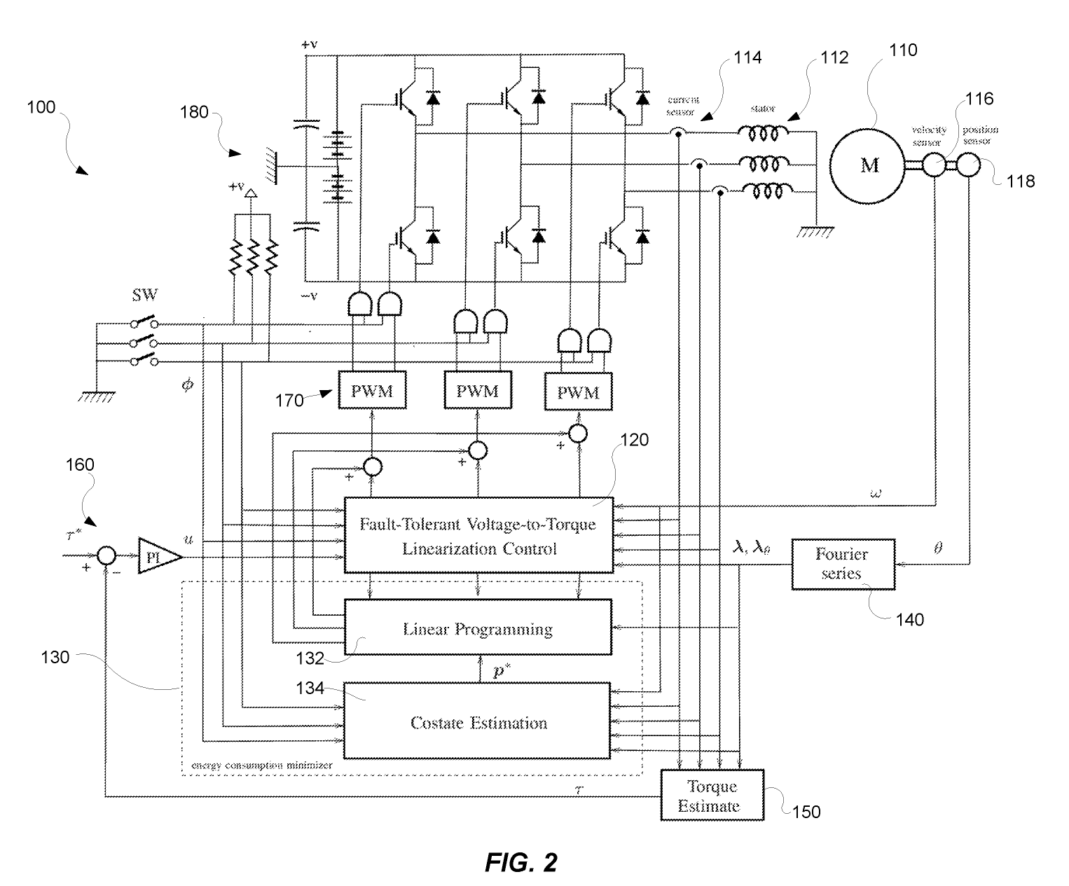

Suppose Ω=\sqrt{kᵢ/μ} is the bandwidth of the closed-loop system, and the proportional gain is selected as kₚ=2μΩ−1 to achieve a critically damped system. Then, the input/output transfer function of the closed-loop system becomes

$$\frac{τ ( s )}{{τ}^{*} ( s )} = \frac{β s + {Ω}^{2}}{{( s + Ω )}^{2}} \qquad ( 49 )$$

where β=2Ω−1/μ. FIG. 2 illustrates schematically the optimal torque control of a three-phase nonsinusoidal PMSM that can be used for a motion servo system, vehicle drive system, or other application.

In the embodiment depicted by way of example in FIG. 2, a fault-tolerant, energy-efficient motor system is generally denoted by reference numeral 100. The system includes a multi-phase permanent magnet synchronous motor 110 (which is synonymously referred to herein as a permanent magnet sychronous machine or simply PMSM). In this example, the motor is a three-phase motor having a stator 112 with three sets of windings. The system 100 also includes a controller for controlling the motor 110. The system includes current sensors 114 for sensing the input currents, an angular velocity sensor 116 for sensing the angular velocity of the motor and an angular position sensor 118 for sensing the angular position of the motor. The controller includes a feedback linearization control module 120 for generating a primary control voltage and an energy minimizer 130 for generating a secondary control voltage. The feedback linearization control module 120 is decoupled from the energy minimizer 130 such that the energy minimizer 130 does not affect the feedback linearization control module 120.

In the embodiment depicted by way of example in FIG. 2, the energy minimizer 130 includes a linear programming module 132 and a costate estimator 134 (also referred to as a costate estimation module).

In the embodiment depicted by way of example in FIG. 2, the system 100 includes a Fourier transform module 140 for converting frequencies into the time domain. The system also includes a torque estimator 150 which estimates motor torque based on the motor sensors. The estimated torque is compared with the required torque τ* by a proportional-integral (PI) controller (PI) 160. An auxiliary control input u is then fed back to the feedback linearization control module 120. The feedback linearization control module 120 outputs signals, one per phase, to pulse width modulators (PWM) 170 which cooperate with transistor-based inverter 180 (together constituting a pulse width modulated inverter) to deliver the input currents to the windings of the motor. Although the permanent magnet synchronous motor described in this example has three phases, it will be appreciated that this control method may be applied to a permanent magnet synchronous motor having a different number of phases.

3. Feedback Linearization Torque Control of Unbalanced Motor with Open-Circuited Phase(s)

This section presents extension of the feedback linearization torque control as described earlier in Section 2 for the case of faulty motors with open circuited phase(s). This provides the motor drive system with fault-tolerant capability for accurate torque production even if one of motor phases or inverter legs fails (multi stream fault condition can be dealt with if the motor has more than three phases).

The torque controller should not energize phases which are isolated due to a fault. Therefore, one can define signature vector σ=[φ₁, . . . , φₚ]^{T} for the control design purpose as follows

$${φ}_{k} = \{ \begin{matrix}1 & for healthy phase \\ 0 & for opern \text{-} circuted phas\end{matrix} ∀ k = 1 , … , p$$

Then, it can be shown that the motor current dynamics with open-circuited phase(s) is governed by the following differential equation

$$μ \frac{di}{dt} + i - \hat{α} {ϕϕ}^{T} i = \frac{1}{R} \hat{D} ( v - λω ) \\ where \\ \hat{D} = diag ( ϕ ) - \hat{α} {ϕϕ}^{T} \qquad ( 50 )$$

and scalar \hat{α} is given by

$$\hat{α} = \frac{{M}_{s}}{( {1}^{T} ϕ - 1 ) {M}_{s} + {L}_{s}}$$

It can be easily verified by inspection that in the case of no fault, when φ=[1, . . . , 1]^{T}, \hat{α}=α, and \hat{D}=D. It is also important to note that in the case of open-circuited phase(s), it may be not always possible to balance the currents of the remaining phases for zero sum to get a stable torque (at least for the case of three-phase motors). Therefore, the current constraint (7) is no longer imposed in the fault-tolerant control law, i.e., unbalanced phase motor

iₒ≠0

From practical a point of view, this means that either the motor's neutral point must be connected to the drive system or phase voltages should be individually controlled by independent amplifiers in order to be able to control the torque of a faulty motor. Consequently, in a development similar to (18)-(19), the torque dynamics equation under open-circuited phase(s) can be obtained by substituting the time-derivative of the current from (50) into (18)

$$τ + μ \dot{τ} = \frac{1}{R} {λ}^{T} \hat{D} v + \frac{ω}{R} {λ}^{T} \hat{D} λ + {μωλ}_{θ}^{T} i + \hat{α} {λ}^{T} {ϕϕ}^{T} i \qquad ( 51 )$$

Now, consider the following feedback linearization law

$$v = {v}_{q} + {v}_{p} \\ where \\ {v}_{p} = ωλ + R ( u - {μωλ}_{θ}^{T} i - \hat{α} {λ}^{T} {ϕϕ}^{T} i ) \frac{\hat{D} λ}{{λ}^{T} {\hat{D} }^{2} λ} \qquad ( 52 )$$

where u is an auxiliary control input and v_{q} is any arbitrary voltage component which satisfies

λ^{T}\hat{D}v_{q}=0 (53)

In other words, identity (52) and (53), respectively, represent the primary control system and the consistency condition of the secondary control voltage variable for the case of unbalanced motors with open-circuited phase(s).

This constraint can be equivalently expressed in terms of projection matrix P, i.e., P²=P, as

Pv_{q}=v_{q} (54)

and P takes the form

$$P = diag ( ϕ ) - \frac{\hat{D} {λλ}^{T} {\hat{D}}^{2}}{{λ}^{T} \hat{D} λ} \qquad ( 55 )$$

Now, one can show that substituting the torque control law (52) in (19) yields the desired input/output linearization

τ+μ\dot{τ}=u (56)

3.1 Energy Minimizer Control with Open-Circuited Phase(s)

By virtue of (19), one can conclude that the secondary voltage input v_{q} does not contribute to the torque production. However, it will be later shown that v_{q} can be used to maximize machine efficiency and enhance its operational speed even though being impotent for torque production. By substituting the linearization control law (52) into the machine voltage equation (50), one arrives at the following time-varying linear system describing the current dynamics in response to the optimal input v_{q}

$$μ \frac{di}{dt} + ( μωΛ + Γ ) i = \frac{{\hat{D}}^{2} λ}{{λ}^{T} {\hat{D}}^{2} λ} u ( t ) + \frac{1}{R} \hat{D} {v}_{q} \qquad ( 57 )$$

where matrices Λ and Γ are defined as

$$Λ = \frac{{\hat{D}}^{2} {λλ}_{θ}^{T}}{{λ}^{T} {\hat{D}}^{2} λ}$$

$$Γ = \hat{α} \frac{{\hat{D}}^{2} {λλ}^{T}}{{λ}^{T} {\hat{D}}^{2} λ} + \hat{D}$$

The above differential equation shows how the secondary voltage input v_{q} affects the phase currents without affecting the resultant motor torque. This will be exploited in the following development to design an optimal control input. It is useful to rewrite the expression of the control law (52) in terms of the primary and secondary voltage components

v=v_{q}+vₚ(u(t),i,θ,ω) (58)

where the primary voltage input vₚ(u(t),i,θ,ω) is responsible for torque production.

The optimal control problem can now be formulated based on the maximum principle from equations (57) and (30) in conjunction with the constraint for permissible optimal controls represented by set V. To obtain an analytical solution for the optimal control v_{q}, let p be the vector of costate variables of the same dimension as the state vector i. Then, the Hamiltonian function can be constructed from (57) and (30) as

$$H = {p}_{o} {‖ i ‖}^{2} + {p}^{T} \frac{di}{dt} \\ H = {p}_{o} ‖ i ‖ - \frac{1}{μ} {p}^{T} ( μωΛ + Γ ) i + \frac{u ( t )}{{λ}^{T} \hat{D} λ} {p}^{T} \hat{D} λ + \frac{1}{μ R} {p}^{T} \hat{D} {v}_{q} \qquad ( 59 )$$

Using the optimality condition (33) yields the time-derivative of costate satisfies

$$\dot{p} = \frac{1}{μ} ( {μωΛ}^{T} + {Γ}^{T} ) p - 2 {p}_{o} i \qquad ( 60 )$$

Finally, in a development similar to (35)-(38), the vector of costate at epoch tₖ is derived as

$${p}_{k}^{*} = {( I + h {ω}_{k} {Λ}_{k} + \frac{h}{μ} {Γ}_{k} )}^{- 1} {i}_{k} \qquad ( 61 )$$

According to the Pontryagin's minimum principle, the optimal control input minimizes the Hamiltonian over the set of all permissible controls and over optimal trajectories of the state i* and costate p*, i.e.,

$${v}_{q} = arg {min}_{{v}_{q} ∈ V} H ( {i}^{*} , {p}^{*} , {v}_{q} , t ) \qquad ( 62 )$$

It can be inferred from the Hamiltonian (59) that the optimal control input v_{q} should be aligned with vector \hat{D}p* at opposite direction. Therefore, the problem of finding optimal v_{q} maximizing the efficiency of a motor with an open-circuited phase and subject to voltage saturation can be equivalently transcrited by

$$minimum {p}^{* T} \hat{D} {v}_{q} \\ subject to {λ}^{T} \hat{D} {v}_{q} = 0 \\ {V}_{lb} \leq {V}_{q} \leq {V}_{ub} \qquad ( 63 )$$

In summary, the solution of optimization programming (63) yields the secondary control input which in conjunction with (52) determine the overall PWM voltage of the inverter in order to achieve accurate torque production and energy minimizer control of unbalanced PMSMs with open-circuited phase(s).
4. Energy Efficient Control of Salient-Pole Synchronous Motors using DQ Transformation Subject to Time-Varying Torque and Velocity

In another aspect, the principles described above can also apply to salient-pole synchronous motors. The voltage equations of synchronous motors with salient-pole can be written in the d, q reference frame by

$$\begin{matrix}{L}_{d} \frac{{di}_{d}}{dt} = - {Ri}_{d} + {L}_{q} {i}_{q} ω + {v}_{d} & ( 63 a ) \\ {L}_{q} \frac{{di}_{q}}{dt} = - {Ri}_{q} + {L}_{d} {i}_{d} ω - ϕ ω + {v}_{q} & ( 63 b )\end{matrix}$$

where L_{q} and L_{d} are the q- and d-axis inductances, i_{q}, i_{d}, v_{q}, and v_{d} are the q-and d-axis currents and voltages, respectively, φ is the motor back EMF constant, and co is motor speed. The equation of motor torque, τ, can be described by

$$τ = \frac{3}{2} p ( {ϕ i}_{q} + ( {L}_{d} - {L}_{q} ) {i}_{d} {i}_{q} ) , \qquad ( 64 )$$

where p is the number of pole pairs. Using (63) in the time-derivative of (64) yields

τ+μ\dot{τ}=b^{T}v+η(i,ω) (65)

where b(i)=└b_{d} b_{q}┘^{T}

$${b}_{d} = \frac{3 p}{2 R} \frac{{L}_{Δ} {L}_{q}}{{L}_{d}} {i}_{q \\} \\ {b}_{q} = \frac{3 p}{2 R} ( ϕ - {L}_{Δ} {i}_{d} ) , \\ η ( i , ω ) = \frac{3 p}{2 R} ( ( {L}_{q} {ϕ i}_{d} - {ϕ}^{2} + ( {L}_{d}^{2} - {L}_{q}^{2} ) {i}_{d}^{2} ) ω - \frac{{L}_{Δ} {L}_{q}}{{L}_{d}} {i}_{d} {i}_{q} ) \\ {L}_{Δ} = {L}_{d} - {L}_{q} , and \\ μ = \frac{{L}_{q}}{R} \qquad ( 66 )$$

is the machine time-constant. The motor phase currents iₐ, i_{b}, and i_{c} are related to the dq currents by

$$[ \begin{matrix}{i}_{d} \\ {i}_{q}\end{matrix} ] = K ( θ ) [ \begin{matrix}{i}_{a} \\ {i}_{b} \\ {i}_{c}\end{matrix} ] \qquad ( 67 )$$

Transformation from dq voltages to u and z control inputs where

$$K ( θ ) = \frac{2}{3} [ \begin{matrix}cos ( p θ ) & cos ( p θ - \frac{2 π}{3} ) & cos ( p θ + \frac{2 π}{3} ) \\ - sin ( p θ ) & - sin ( p θ - \frac{2 π}{3} ) & - sin ( p θ + \frac{2 π}{3} )\end{matrix} ]$$

is the Park-Clarke transformation and θ is the mechanical angle.

Define control inputs u and z obtained by the following transformation of the dq voltages

$$[ \begin{matrix}u \\ z\end{matrix} ] = {B}^{- 1} v + \frac{b}{{‖ b ‖}^{2}} η where \\ {B}^{- 1} = [ \begin{matrix}{b}_{d} & {b}_{q} \\ - {b}_{q} & {b}_{d}\end{matrix} ] and B = \frac{1}{{‖ b ‖}^{2}} [ \begin{matrix}{b}_{d} & - {b}_{q} \\ {b}_{q} & {b}_{d}\end{matrix} ] \qquad ( 68 )$$

The inverse of transformation (68) is

$$v = B [ \begin{matrix}u - η \\ z\end{matrix} ] \qquad ( 69 )$$

By inspection one can verify that

b^{T}B=[1 0] (70)

Substituting the control input (69) into the time-derivative of motor torque in (65) yields the following linear system

τ+μτ≐u (71)

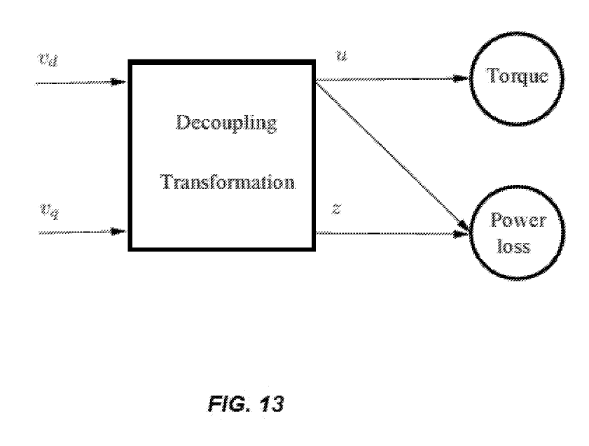

It is apparent from (71) that input z does not contribute to the motor torque generation and control input u exclusively responsible for the torque. As illustrated in FIG. 13, equation (69) can be interpreted as an inverse transform from the dq voltages to u and z. Only input u affects the torque generation. Therefore, we treat u and z as the torque control input and energy minimizer control input, respectively.

By substituting the linearization control law (69) into the machine voltage equations (63), we arrive at the following time-varying linear system describing the dynamics of the currents in response to the control inputs u and z

$$\frac{di}{dt} = {L}^{- 1} ( B [ \begin{matrix}u \\ z\end{matrix} ] + φ ( i , ω ) ) , \qquad ( 72 )$$

where L=diag{L_{d}, L_{q}}, i=[i_{d}i_{q}]^{T}, and vector φ is defined as

$$φ = [ \begin{matrix}- {Ri}_{d} + {L}_{d} {i}_{q} ω \\ - {Ri}_{q} + {L}_{d} {i}_{d} ω - ϕ ω\end{matrix} ] - \frac{b}{{‖ b ‖}^{2}} η$$

The cost function to minimize is power dissipation due to the copper loss over interval h, i.e.,

J=∫ₜ^{T}∥i(ζ)∥²dζ (73)

where T=t+h is the terminal time of the system. Then, the Hamiltonian function can be constructed from (72) and (73) as

$$H = {‖ i ‖}^{2} = {λ}^{T} \frac{di}{dt} = {‖ i ‖}^{2} + {λ}^{T} {L}^{- 1} ( B [ \begin{matrix}u \\ z\end{matrix} ] + φ ( i , ω ) ) ,$$

(74) where λ ε [symbol] ² is the costate vector. The optimality condition stipulates that the time-derivative of costate satisfies

$$λ = - \frac{\partial H}{\partial i}$$

Therefore, the evolution of the costate is governed by the following time-varying differential equation

$$\dot{λ} = {A}^{T} λ - 2 i where \\ A = {L}^{- 1} ( \frac{\partial }{\partial i} B ( i ) [ \begin{matrix}u \\ z\end{matrix} ] + \frac{\partial }{\partial i} φ ( i , ω ) ) \qquad ( 76 )$$

Dynamics equation (76) can be used as an observer to estimate the costate λ. We can write the equivalent discrete-time model of the continuous system (76) as

$$\frac{1}{h} ( {λ}_{k + 1} - {λ}_{k} ) = - {A}_{k}^{T} {λ}_{k} - 2 {i}_{k} \qquad ( 77 )$$

Using the boundary condition λₖ₊₁=0 in the above equation, we get

$${λ}_{k} = - 2 {( {A}_{k}^{T} + \frac{1}{h} I )}^{- 1} {i}_{k} \qquad ( 78 )$$

Moreover, according to the Pontryagin's minimum principle, the optimal control input minimizes the Hamiltonian over the set of all permissible controls and over optimal trajectories of the state i* and costate λ*, i.e.,

$$z = arg {min}_{z ∈ V} H ( {i}^{*} , {λ}^{*} , z ) \qquad ( 79 )$$

It can be inferred from the expression of Hamiltonian (74) that (79) is tantamount to minimizing (L⁻¹λ)^{T}dz, where

$$d = [ \begin{matrix}- {b}_{q} \\ {b}_{d}\end{matrix} ] \\ Thus z = - \vert z \vert sgn ( {λ}^{T} {L}^{- 1} d ) \qquad ( 80 )$$

The magnitude of control input z should be large as possible as long as the voltage vector does not reach its saturation limit, i.e.,

∥v∥≦vₘₐₓ (81)

where vₘₐₓ is the maximum voltage. From (69), we can say

$${‖ v ‖}^{2} = \frac{{( u - η )}^{2} + {z}^{2}}{{‖ b ‖}^{2}} \qquad ( 82 )$$

In view of (81) and (82), the maximum allowable magnitude of control input z is

|z|≦\sqrt{vₘₐₓ²∥b∥²−(u−η)²} (84)

Finally, from (80) and (83), one can describe the optimal control input maximizing the motor efficiency and deterring voltage saturation by the following expression

z=−sgn(λ^{T}L⁻d)\sqrt{vₘₐₓ²∥b∥²−(u−η)²} (84)

Note that the expression under the square-root in (84) must be positive to ensure real-valued solution for the control input z and that requires

vₘₐₓ∥b∥≧|u−η|.

Therefore, the value of the torque command should be within the following bands

uₘᵢₙ≦u≦uₘₐₓ (85)

where

uₘᵢₙ=η−∥b∥vₘₐₓ and uₘₐₓ=η+∥b∥vₘₐₓ

In other words, the torque control input u must be checked for saturation avoidance according to

$$u = \{ \begin{matrix}{u}_{max} & if u > {u}_{max} \\ u & if {u}_{min} \leq u \leq {u}_{max} \\ {u}_{min} & if u < {u}_{min}\end{matrix} \qquad ( 86 )$$

Now with u and z in hand, one may use (69) to calculate dq voltage. Finally, the inverter phase voltages can be obtained from

$$[ \begin{matrix}{v}_{a} \\ {v}_{b} \\ {v}_{c}\end{matrix} ] = {K}^{- 1} ( θ ) [ \begin{matrix}{v}_{d} \\ {v}_{q}\end{matrix} ] \\ Where \\ {K}^{- 1} ( θ ) [ \begin{matrix}cos ( p θ ) & - sin ( p θ ) \\ cos ( p θ - \frac{2 π}{3} ) & - sin ( p θ - \frac{2 π}{3} ) \\ cos ( p θ + \frac{2 π}{3} ) & - sin ( p θ + \frac{2 π}{3} )\end{matrix} ] \qquad ( 87 )$$

is the inverse Park-Clarke transform.

In summary, the energy efficient torque control of salient-pole synchronous motors may proceed with the following steps:
1. Acquire data pertaining to shaft position and speed, and the phase currents from sensors. Then, compute dq currents from Park-Clarke transform (67).
2. Given torque command u and maximum voltage limit vₘₐₓ, limit the magnitude of the command according to (86).
3. Use estimator (76) or (78) to estimate the costate vector X.
4. Compute the energy minimizer control input z from (84).
5. With u and z in hand, compute the dq voltage from hybrid linearization control law (69). Then, compute the inverter phase voltages from the inverse Park-Clarke transform according to (87).

### 5. Experimental Results

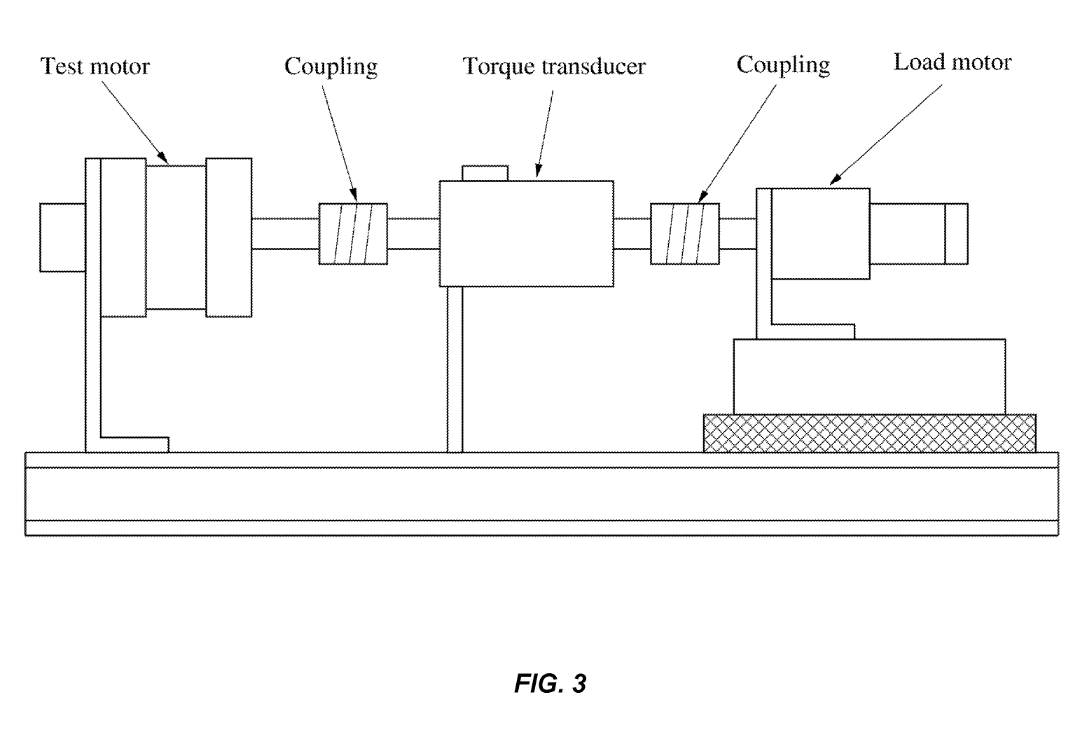

In order to evaluate the performance of the energy-efficient torque controller to track time-varying torque commands, experiments were conducted on a three-phase synchronous motor having an electric time-constant of μ=5 ms. Three independent pulse width modulation (PWM) servo amplifiers controlled the motor's phase voltages as specified by the torque controller. The mechanical load condition of the electric motor was provided by a load motor whose speed was regulated using the test setup shown in FIG. 3.

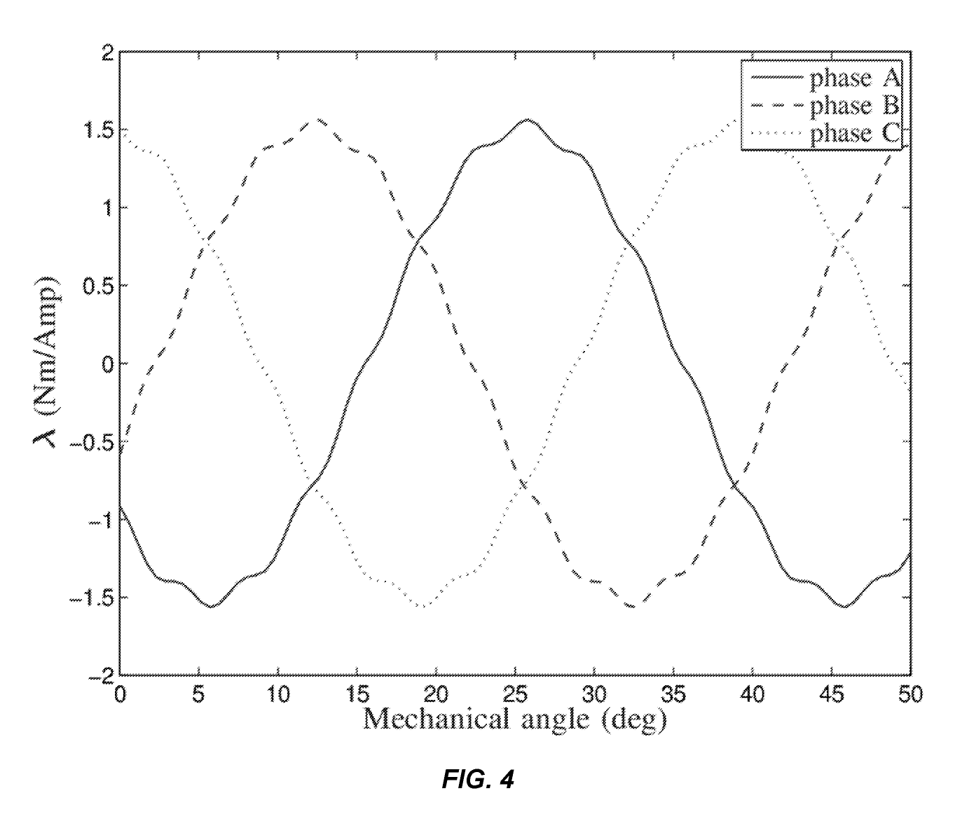

The back electromotive force (back-EMF) waveforms were measured by using a dynamometer as shown in FIG. 3. Knowing that the per-phase back-EMF function and torque function have the same waveshape dictated by the airgap flux density, the back-EMF function is experimentally identified by measuring the torque produced by the individual motor phases at different mechanical angles. To this end, the torque trajectory data versus position was recorded during the rotation, while one phase is energized at a time and its current is held constant constant. FIG. 4 illustrates the per-phase torque functions in terms of the mechanical angles of the motor. Note that the per-phase torque function is identical to the per-phase back-EMF function, as needed for the torque control synthesis. Since the motor has nine pole pairs, the torque trajectory is periodic in position with a fundamental spatial-frequency of 9 cpr (cycles/revolution) and thus the torque pattern repeats every 40 degrees.

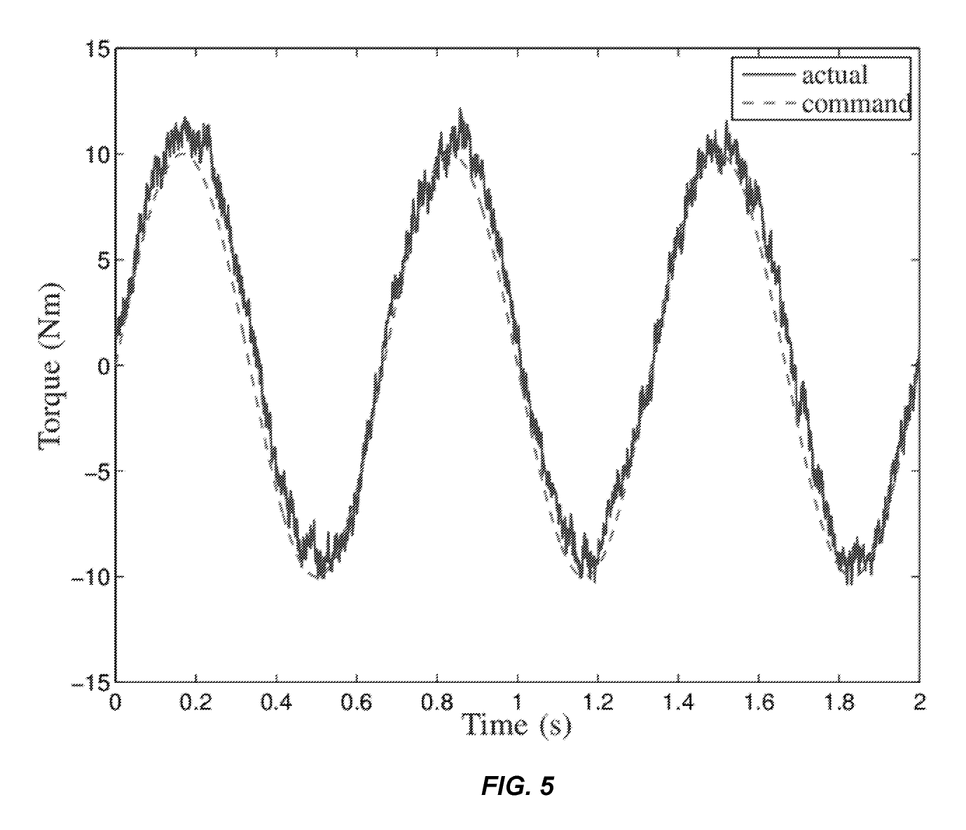

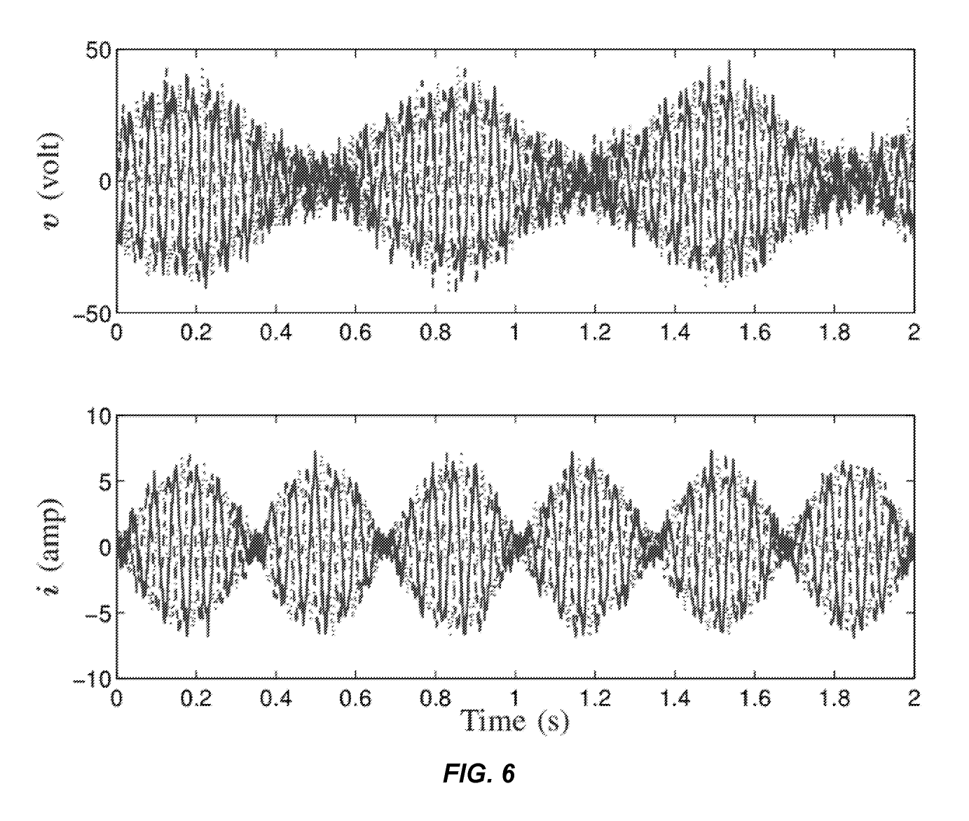

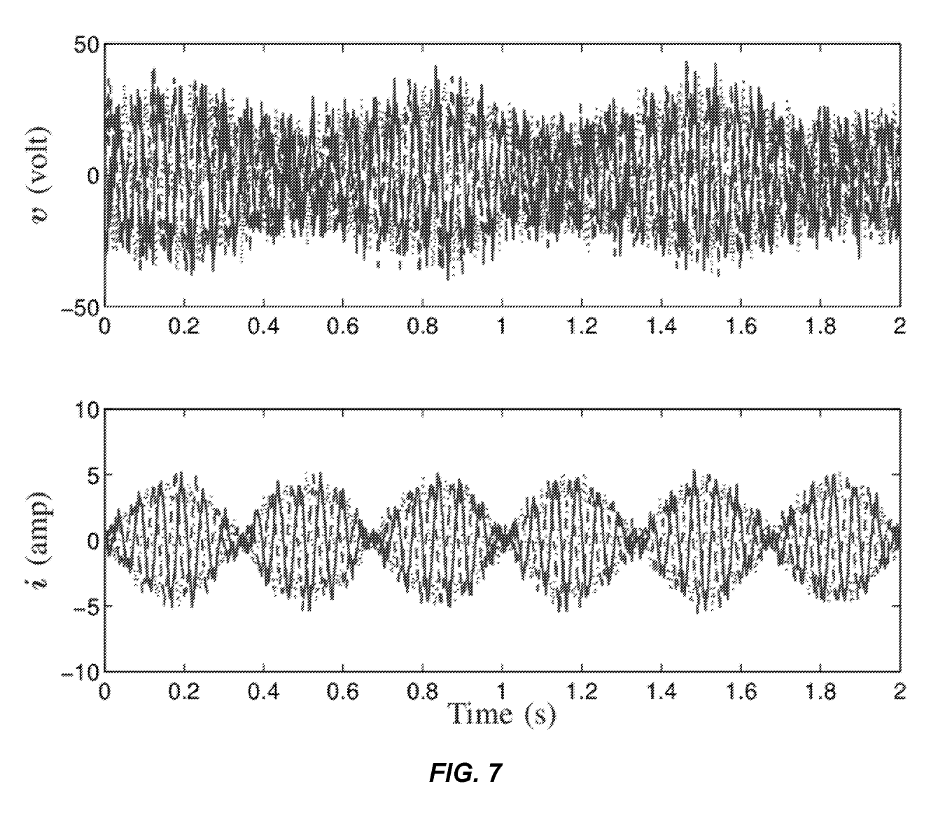

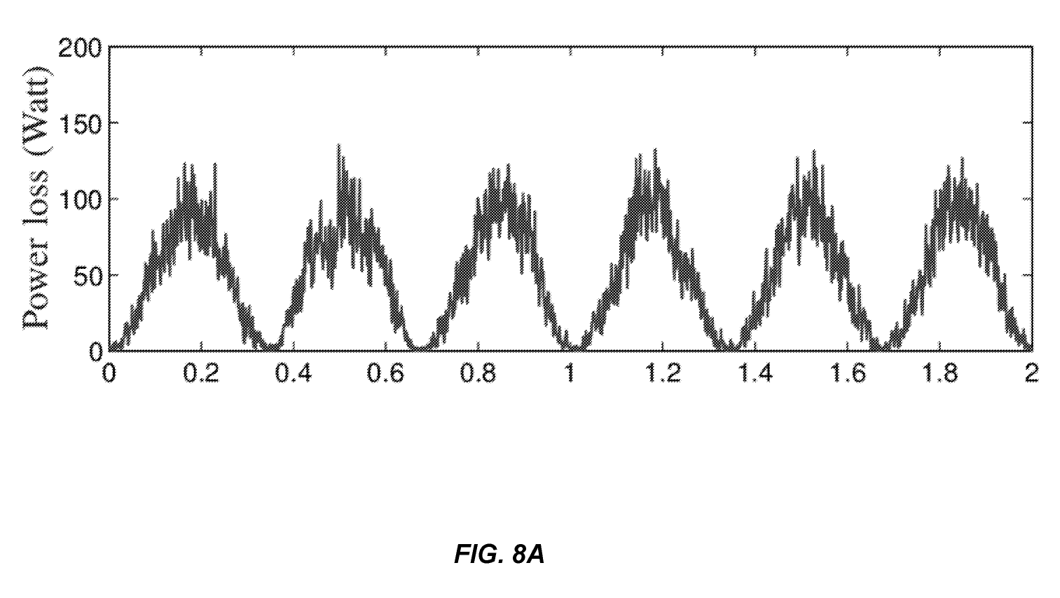

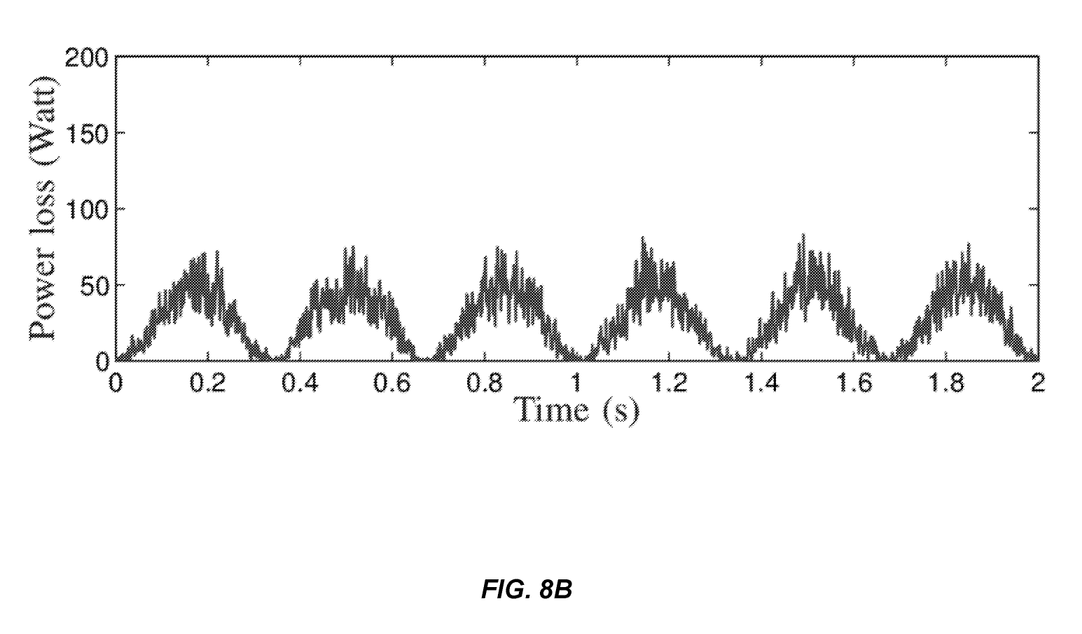

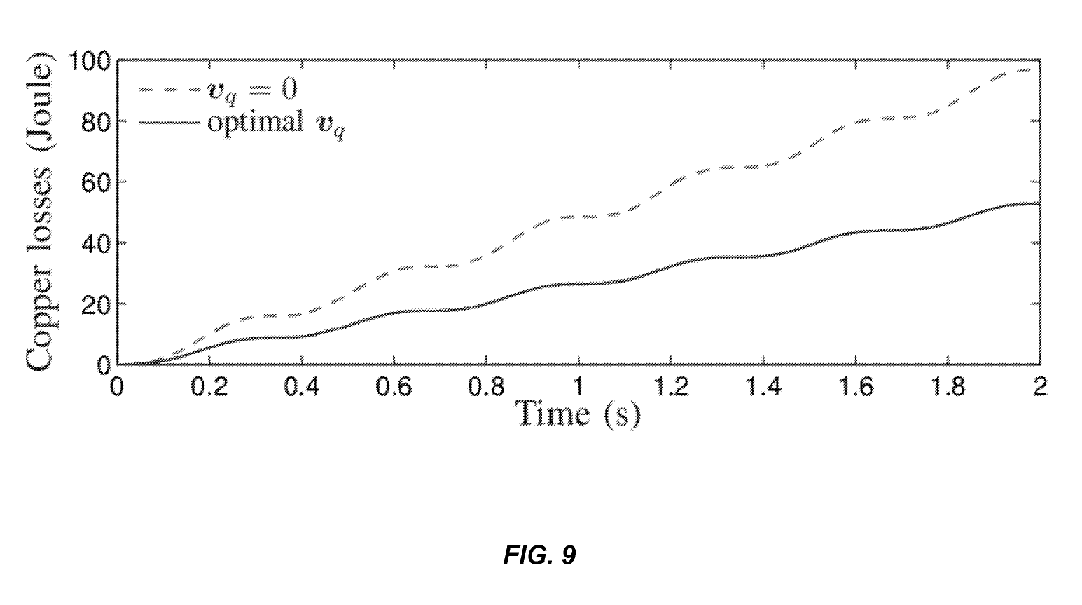

FIG. 5 shows the performance of the torque controller in tracking a 2 Hz sinusoidal reference trajectory while the motor shaft angular speed is actively regulated at 25 rad/s by the hydraulic load motor. The time-histories of the voltage control input and phase currents without, and using, energy-efficient control feedback are plotted in FIGS. 6 and 7, respectively. The corresponding instantaneous power dissipations are calculated from the phase currents and the results are shown in FIGS. 8A and 8B. FIG. 8A shows power dissipation for the motor operating without the optimal controller v_{q}=0 whereas FIG. 8B shows the power dissipation of the motor operating with the optimal controller. The optimal controller significantly reduces the power dissipation leading to energy efficiency as comparatively demonstrated in FIG. 9. As shown in FIG. 9, there is less power dissipation when the motor is operating with the optimal control than when the motor is operating without the optimal control. This result suggests that the controller reduces power consumption for the motor. The controller thus makes the motor more energy-efficient, thereby prolong battery life and/or extending operating ranges.

### 4.1 Open-Circuited Phase

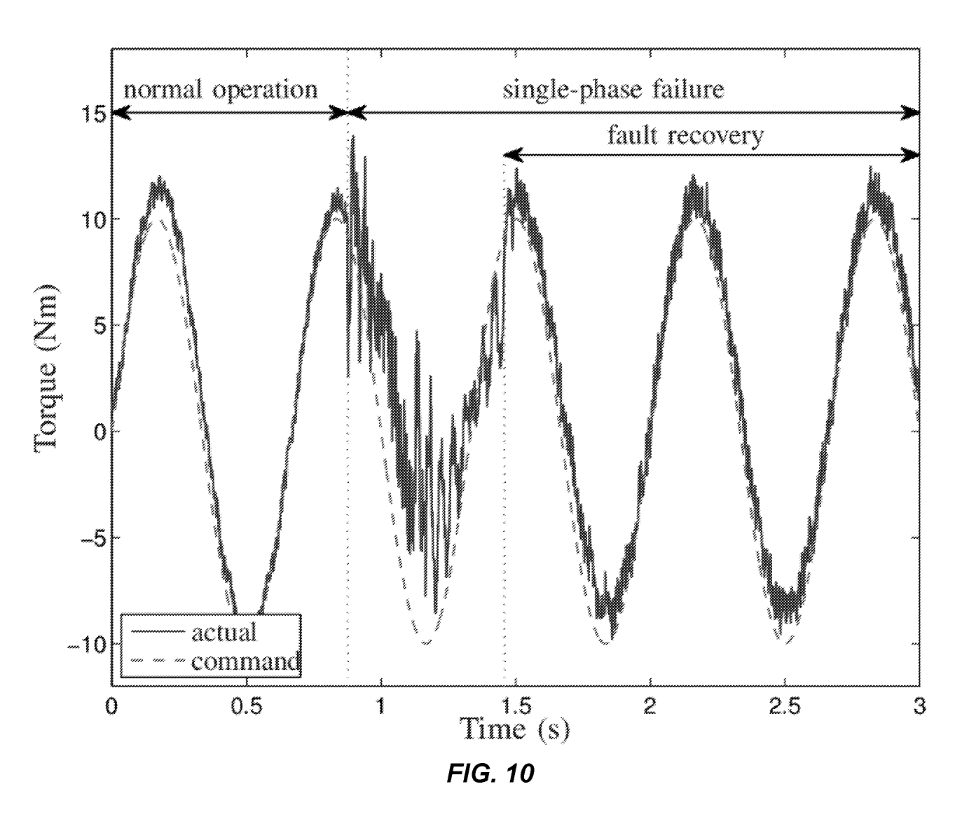

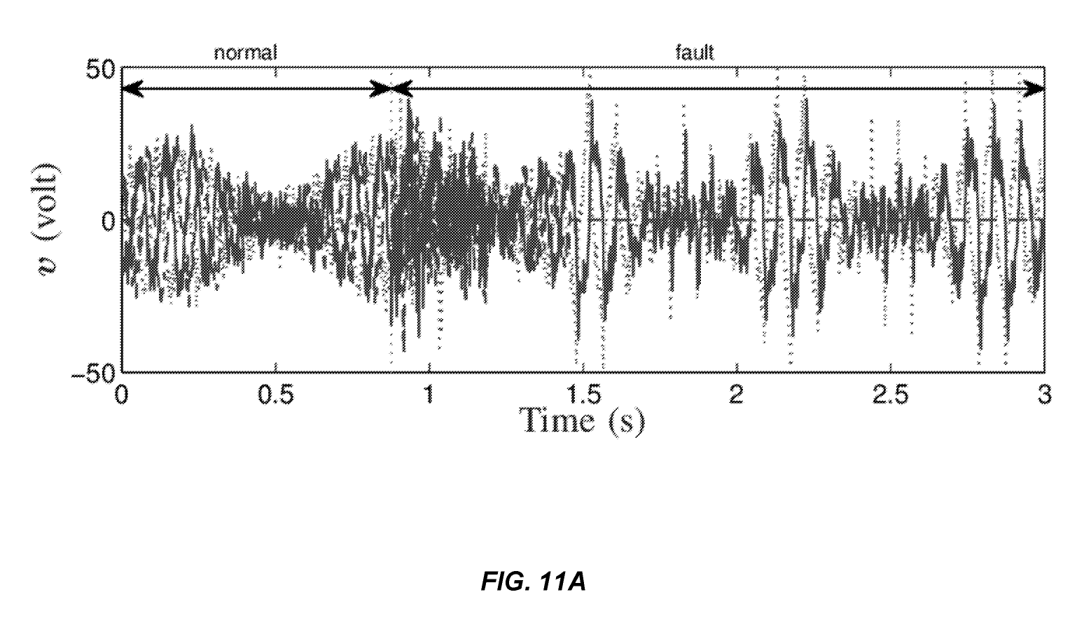

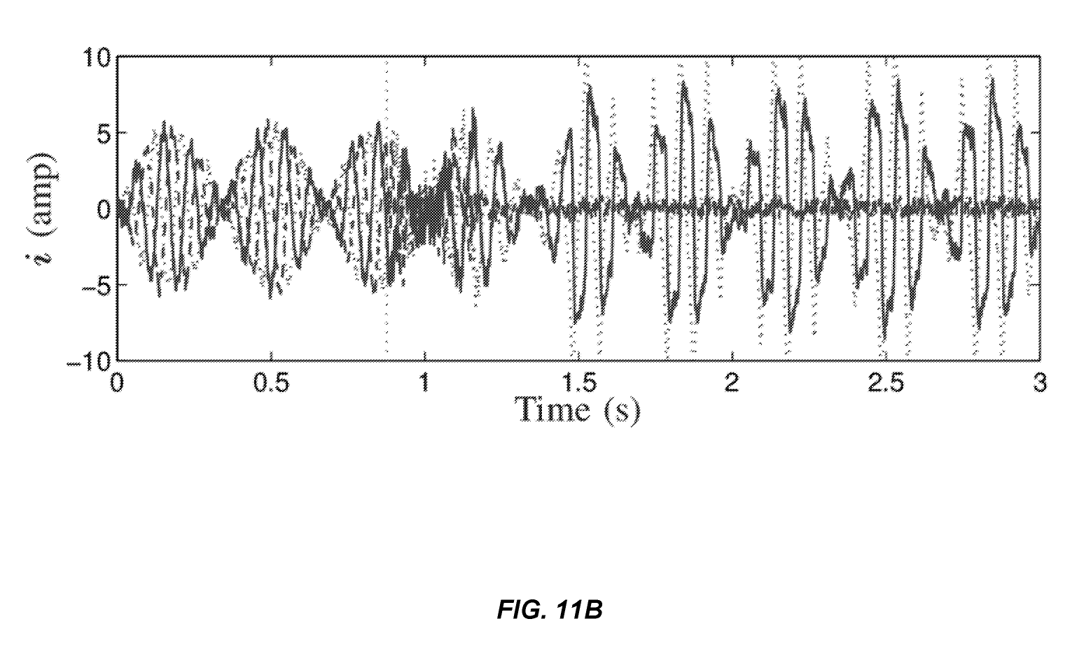

The feedback linearization torque controller can be readily used as a remedial control strategy in response to a single-phase failure. To validate this functionality, an experiment was performed during which the circuit of the motor's third phase (phase 3) was intentionally open-circuited. The control objective was to track the sinusoidal reference torque trajectory using only the two remaining phases. FIG. 10 shows the motor torque trajectory under a normal operating condition and under a faulty operating condition due to a single-phase failure. This figure also shows the dynamic transition. As shown in the figure, one of the motor phases, e.g. phase 3, was intentionally open-circuited at about time t=0.78 s while a full recovery of motor torque production to track the desired sinusoidal trajectory is achieved shortly afterward. The waveforms of the voltage control inputs and the drive currents during the transition from the normal operating condition to the single-phase failure condition are depicted in FIGS. 11A and 11B, respectively.

The disclosed controller and control method enables a permanent magnet synchronous machine (or motor) to generate torque accurately and efficiently whether or not one of the motor phases is open-circuited. The controller enables the motor to generate torque efficiently in response to time-varying torque commands or time-varying operational velocity. The controller generates a primary control voltage vₚ and a secondary control voltage v_{q} for a pulse width modulated inverter associated with the multi-phase permanent magnet synchronous motor. The voltage control input of the inverter is orthogonally decomposed into the primary control voltage vₚ and the secondary control input v_{q} in such a way that the latter control input v_{q} becomes perpendicular to the projected version of the vector of the flux linkage derivative \hat{D}λ. This decomposition decouples the feedback linearization control from the energy minimizer control, meaning that the energy minimizer control does not affect the result of the fault-tolerant feedback linearization control.

The controller includes a fault-tolerant feedback linearization control module cascaded with an energy minimizer to maximize motor efficiency while delivering the requested torque even with an open-circuited phase, with time-varying torque commands, or the requested velocity, even with an open-circuited phase, with time-varying operational velocity. The energy minimizer, which generates the secondary control voltage v_{q}, includes a costate estimator cascaded with a constrained linear programming module. To maximize efficiency, the secondary phase voltage is aligned with the projected version of the estimated costate vector as much as possible. The secondary control voltage is subject to an inequality control v_{lb}≦v_{q}≦v_{ub} in order to avoid saturation, where the lower-bound and upper-bound limits are obtained from values of the maximum inverter voltage and the instantaneous primary voltage control. The secondary control voltage v_{q} is subject to the following constraint λ′^{T}\hat{D}v_{q}=0 so that the energy minimizer does not affect the linearization control module. The optimal value of v_{q} maximizing motor efficiency for the best possible alignment with the projected costate vector without causing saturation of the overall inverter voltage is obtained from the linear programming (46), which has a linear cost function and a set of linear equality and inequality constraints.

The controller in conjunction with the motor thus provide a fault-tolerant, energy-efficient motor system comprising a multi-phase permanent magnet synchronous motor and a controller for controlling the motor. The controller includes a feedback linearization control module for generating a primary control voltage and an energy minimizer for generating a secondary control voltage, wherein the feedback linearization control module is decoupled from the energy minimizer such that the energy minimizer does not affect the feedback linearization control module. The motor system is useful in a variety of electromechanical or mechatronic applications such as, but not limited to, electric or hybrid-electric drive systems or servo-control systems for vehicles, such as automobiles, trucks, buses, etc, or extraterrestrial rovers. The motor system is useful also in robotics, manufacturing systems, or other servo-driven mechanisms, to name but a few potential uses of this motor system.

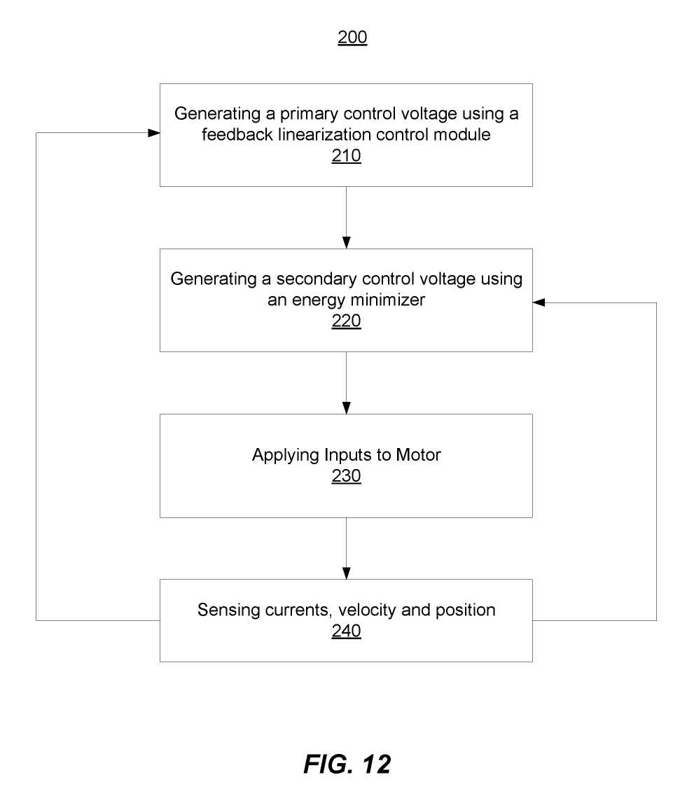

The control method, i.e. the method of controlling a multi-phase permanent magnet synchronous motor, is generally outlined in FIG. 12. As presented in this figure, the method 200 entails a step 210 of generating a primary control voltage using a feedback linearization control module and a step 220 of generating a secondary control voltage using an energy minimizer, wherein the feedback linearization control module is decoupled from the energy minimizer such that the energy minimizer does not affect the feedback linearization control module. The steps 210, 220 of this control method 200 may be performed sequentially or simultaneously or in a partially overlapping manner. At step 230, the currents are applied to the motor. At step 240, the input currents, motor velocity and angular position are sensed by current sensors, a velocity sensor and a position sensor, respectively. This sensor data is fed back to the feedback linearization control module and the energy minimizer.

The controller, control system and control method described herein may be implemented in hardware, software, firmware or any suitable combination thereof. Where implemented as software, the method steps, acts or operations may be programmed or coded as computer-readable instructions and recorded electronically, magnetically or optically on a fixed, permanent, non-volatile or non-transitory computer-readable medium, computer-readable memory, machine-readable memory or computer program product. In other words, the computer-readable memory or computer-readable medium comprises instructions in code which when loaded into a memory and executed on a processor of a computing device cause the computing device to perform one or more of the foregoing method(s).

A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

The following publications are herein incorporated by reference without limiting the generality of the foregoing:
[1] H. van de Straete, P. Degezelle, J. De Schutter, and R. J. M. Belmans, “Servo motor selection criterion for mechatronic applications,” Mechatronics, IEEE/ASME Transactions on, vol. 3, no. 1, pp. 43-50, March 1998.
[2] Y. Chen and J. Wang, “Design and experimental evaluations on energy efficient control allocation methods for overactuated electric vehicles: Longitudinal motion case,” Mechatronics, IEEE/ASME Transactions on, vol. 19, no. 2, pp. 538-548, April 2014.
[3] G. Foo, X. Zhang, and D. Vilathgamuwa, “Sensor fault-resilient control of interior permanent-magnet synchronous motor drives,” Mechatronics, IEEE/ASME Transactions on, vol. 20, no. 2, pp. 855-864, April 2015.
[4] D. G. Taylor, “Nonlinear control of electric machines: An overview,” IEEE Control Systems Magazine, vol. 14, no. 6, pp. 41-51, 1994.
[5] C. French and P. Acarnley, “Direct torque control of permanent magnet drives,” IEEE Trans. on Industry Applications, vol. 32, no. 5, pp. 1080-1088, September-October 1996.
[6] J.-K. Kang and S.-K. Sul, “New direct torque control of induction motor for minimum torque ripple and constant switching frequency,” IEEE Trans. on Industry Applications, vol. 35, no. 5, pp. 1076-1082, September-October 1999.
[7] F. Aghili, M. Buehler, and J. M. Hollerbach, “Optimal commutation laws in the frequency domain for PM synchronous direct-drive motors,” IEEE Transactions on Power Electronics, vol. 15, no. 6, pp. 1056-1064, November 2000.
[8] S. J. Park, H. W. Park, M. H. Lee, and F. Harashima, “A new approach for minimum-torque-ripple maximum-efficiency control of BLDC motor,” IEEE Trans. on Industrial Electronics, vol. 47, no. 1, pp. 109-114, February 2000.
[9] F. Aghili, M. Buehler, and J. M. Hollerbach, “Experimental characterization and quadratic programming-based control of brushless-motors,” IEEE Trans. on Control Systems Technology, vol. 11, no. 1, pp. 139-146, 2003.
[10] Y. Wang, D. Cheng, C. Li, and Y. Ge, “Dissipative Hamiltonian realization and energy-based L2-disturbance attenuation control of multimachine power systems,” IEEE Trans. on Automatic Control, vol. 48, no. 8, pp. 1428-1433, August 2003.
[11] Z. Xu and M. F. Rahman, “A variable structure torque and flux controller for a DTC IPM synchronous motor drive,” in IEEE 35th Annual Power Electronics Specialists Conference, PESC 4, Jun. 2004, pp. 445-450, Vol. 1.
[12] L. Bascetta, P. Rocco, and G. Magnani, “Force ripple compensation in linear motors based on closed-loop position-dependent identification,” Mechatronics, IEEE/ASME Transactions on, vol. 15, no. 3, pp. 349-359, June 2010.
[13] R. Ortega, L. Praly, A. Astolfi, J. Lee, and K. Nam, “Estimation of rotor position and speed of permanent magnet synchronous motors with guaranteed stability,” Control Systems Technology, IEEE Transactions on, vol. 19, no. 3, pp. 601-614, May 2011.
[14] S. Ozturk and H. Toliyat, “Direct torque and indirect flux control of brushless dc motor,” Mechatronics, IEEE/ASME Transactions on, vol. 16, no. 2, pp. 351-360, April 2011.
[15] D. Grenier, L.-A. Dessaint, O. Akhrif, and J.-P. Louis, “A park-like transformation for the study and the control of a nonsinusoidal brushless dc motor,” in Industrial Electronics, Control, and Instrumentation, 1995., Proceedings of the 1995 IEEE IECON 21st International Conference on, vol. 2, November 1995, pp. 836-843 vol. 2.
[16] A. Kaddouri, O. Akhrif, H. Le-Huy, and M. Ghribi, “Nonlinear feedback control of a permanent magnet synchronous motors,” in Electrical and Computer Engineering, 1994. Conference Proceedings. 1994 Canadian Conference on, September 1994, pp. 77-80 vol. 1.
[17] M. Bodson, J. Chiasson, R. Novotnak, and R. Rekowski, “High-performance nonlinear feedback control of a permanent magnet stepper motor,” Control Systems Technology, IEEE Transactions on, vol. 1, no. 1, pp. 5-14, March 1993.
[18] D. Grenier, L.-A. Dessaint, O. Akhrif, Y. Bonnassieux, and B. Le Pioufle, “Experimental nonlinear torque control of a permanent-magnet synchronous motor using saliency,” Industrial Electronics, IEEE Transactions on, vol. 44, no. 5, pp. 680-687, October 1997.
[19] I. Takahashi and T. Noguchi, “A new quick-response and high-efficiency control strategy of an induction motor,” Industry Applications, IEEE Transactions on, vol. IA-22, no. 5, pp. 820-827, September 1986.
[20] L. Zhong, M. Rahman, W. Y. Hu, and K. W. Lim, “Analysis of direct torque control in permanent magnet synchronous motor drives,” Power Electronics, IEEE Transactions on, vol. 12, no. 3, pp. 528-536, May 1997.
[21] Y. Zhang and J. Zhu, “Direct torque control of permanent magnet synchronous motor with reduced torque ripple and commutation frequency,” Power Electronics, IEEE Transactions on, vol. 26, no. 1, pp. 235-248, January 2011.
[22] K. Gulez, A. Adam, and H. Pastaci, “A novel direct torque control algorithm for ipmsm with minimum harmonics and torque ripples,” Mechatronics, IEEE/ASME Transactions on, vol. 12, no. 2, pp. 223-227, April 2007.
[23] Y. Cho, D.-H. Kim, K.-B. Lee, Y. I. Lee, and J.-H. Song, “Torque ripple reduction and fast torque response strategy of direct torque control for permanent-magnet synchronous motor,” in Industrial Electronics (ISIE), 2013 IEEE International Symposium on, May 2013, pp. 1-6.
[24] J.-J. Chen and K.-P. Chin, “Automatic flux-weakening control of permanent magnet synchronous motors using a reduced-order controller,” Power Electronics, IEEE Transactions on, vol. 15, no. 5, pp. 881-890, September 2000.
[25] Z. Zhu, Y. Chen, and D. Howe, “Online optimal flux-weakening control of permanent-magnet brushless ac drives,” Industry Applications, IEEE Transactions on, vol. 36, no. 6, pp. 1661-1668, November 2000.
[26] J.-J. Chen and K.-P. Chin, “Minimum copper loss flux-weakening control of surface mounted permanent magnet synchronous motors,” Power Electronics, IEEE Transactions on, vol. 18, no. 4, pp. 929-936, July 2003.
[27] H.-H. Chiang, K.-C. Hsu, and I.-H. Li, “Optimized adaptive motion control through an sopc implementation for linear induction motor drives,” Mechatronics, IEEE/ASME Transactions on, vol. 20, no. 1, pp. 348-360, February 2015.
[28] T. D. Do, H. H. Choi, and J.-W. Jung, “Sdre-based near optimal control system design for pm synchronous motor,” Industrial Electronics, IEEE Transactions on, vol. 59, no. 11, pp. 4063-4074, November 2012.
[29] P. Krishnamurthy and F. Khorrami, “An analysis of the effects of closed-loop commutation delay on stepper motor control and application to parameter estimation,” Control Systems Technology, IEEE Transactions on, vol. 16, no. 1, pp. 70-77, January 2008.
[30] S. H. Chu and I. J. Ha, “Control of hybrid step motors via a simplified linearization technique,” Int. Journal of Control, vol. 61, no. 5, pp. 1143-1167, 1995.
[31] H. Le-Huy, K. Slimani, and P. Viarouge, “Analysis and implementation of a real-time predictive current controller for permanent-magnet synchronous servo drives,” in Industry Applications Society Annual Meeting, 1991., Conference Record of the 1991 IEEE, September 1991, pp. 996-1002 vol. 1.
[32] S. Buso, L. Malesani, and P. Mattavelli, “Comparison of current control techniques for active filter applications,” Industrial Electronics, IEEE Transactions on, vol. 45, no. 5, pp. 722-729, October 1998.
[33] M. Kazmierkowski and L. Malesani, “Current control techniques for three-phase voltage-source pwm converters: a survey,” Industrial Electronics, IEEE Transactions on, vol. 45, no. 5, pp. 691-703, October 1998.
[34] T. Jahns and W. Soong, “Pulsating torque minimization techniques for permanent magnet ac motor drives-a review,” Industrial Electronics, IEEE Transactions on, vol. 43, no. 2, pp. 321-330, April 1996.
[35] D. Wang, X. Wang, Y. Yang, and R. Zhang, “Optimization of magnetic pole shifting to reduce cogging torque in solid-rotor permanent-magnet synchronous motors,” Magnetics, IEEE Transactions on, vol. 46, no. 5, pp. 1228-1234, May 2010.
[36] D. Grenier, S. Yala, O. Akhrif, and L.-A. Dessaint, “Direct torque control of pm ac motor with non-sinusoidal flux distribution using state-feedback linearization techniques,” in Industrial Electronics Society, 1998. IECON '98. Proceedings of the 24th Annual Conference of the IEEE, vol. 3, August 1998, pp. 1515-1520 vol. 3.
[37] D. Flieller, N. K. Nguyen, P. Wira, G. Sturtzer, D. Abdeslam, and J. Merckle, “A self-learning solution for torque ripple reduction for nonsinusoidal permanent-magnet motor drives based on artificial neural networks,” Industrial Electronics, IEEE Transactions on, vol. 61, no. 2, pp. 655-666, February 2014.
[38] H. Le-Huy, R. Perret, and R. Feuillet, “Minimization of torque ripple in brushless dc motor drives,” Industry Applications, IEEE Transactions on, vol. IA-22, no. 4, pp. 748-755, July 1986.
[39] K. y. Cho, J.-D. Bae, S.-K. Chung, and M. J. Youn, “Torque harmonics minimization in pm synchronous motor with back emf estimation,” in TENCON '93. Proceedings. Computer, Communication, Control and Power Engineering. 1993 IEEE Region 10 Conference on, no. 0, October 1993, pp. 589-593 vol. 5.
[40] P. C. Krause, Analysis of Electric Machinery. McGraw-Hill, 1986.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. A controller for controlling a multi-phase permanent magnet synchronous motor, to enable operation of the motor even if one or more phases are open-circuited, the controller comprising:
a feedback linearization control module for generating a primary control voltage; and
an energy minimizer for generating a secondary control voltage;
wherein the primary and secondary control voltages are an orthogonal decomposition of a phase voltage vector and therefore the feedback linearization control module is decoupled from the energy minimizer such that the energy minimizer does not affect the feedback linearization control module.

2. The controller of claim 1 wherein the secondary control voltage defines a secondary control voltage vector that is perpendicular to a projected version of a flux linkage derivative vector.

3. The controller of claim 1 wherein the energy minimizer comprises a constrained linear programming module and a costate estimator.

4. The controller of claim 1 wherein the feedback linearization control module receives feedback from measured phase currents, motor shaft angle, motor speed, and instantaneous values of a reference torque and a signature vector indicating which phase is open-circuited and then generates the primary control voltage for a pulse width modulated inverter associated with the motor to establish a first-order linear dynamics relationship between reference and generated torques to thereby control the motor.

5. The controller of claim 2 wherein the costate estimator computes costate variables relating to a state of the energy minimizer based on feedback signals including measured phase currents, motor shaft angle, motor speed, and instantaneous values of a reference torque and a signature vector.

6. The controller of claim 5 wherein the energy minimizer determines the secondary control voltage by aligning the secondary phase voltage with a projected version of an estimated costate vector to maximize efficiency.

7. The controller of claim 6 wherein the secondary control voltage v_{q} is constrained by v_{lb}≦v_{q}≦v_{ub} to avoid saturation where lower-bound voltage v_{lb} and upper-bound voltage v_{ub} are obtained from values of a maximum inverter voltage and an instantaneous primary voltage control.

8. The controller of claim 7 wherein the secondary control voltage v_{q} is subject to a consistency constraint λ′^{T}\hat{D}v_{q}=0 for unbalanced motors with open-circuited phase(s) such that the energy minimizer does not affect the linearization control module.

9. The controller of claim 7 wherein the secondary control voltage v_{q} is subject to a consistency constraint [1 λ′]^{T}v_{q}=0, for balanced motors such that there is no need for a neutral line point such that the energy minimizer does not affect the linearization control module.

10. The controller of claim 1 wherein the secondary control voltage v_{q} is optimized for maximum efficiency of unbalanced motors with open-circuited motors by solving constrained linear programming:
$$\begin{matrix}minimum & {p}^{{}^{*} T} \hat{D} {v}_{q} \\ subject to & {λ}^{T} \hat{D} {v}_{q} = 0 \\ & {v}_{lb} \leq {v}_{q} \leq {v}_{ub}\end{matrix}$$

11. The controller of claim 10 wherein the optimal value of the costate vector p*ₖ at epoch tₖ is estimated from
$${p}_{k}^{*} = {( I + h {ω}_{k} {Λ}_{k} + \frac{h}{μ} {Γ}_{k} )}^{- 1} {i}_{k}$$

12. The controller of claim 1 wherein the primary control voltage vₚ to achieve accurate torque production of unbalanced motors with open-circuited motors is obtained from the following nonlinear feedback
$${v}_{p} = ωλ + R ( u - {μωλ}_{θ}^{T} i - \hat{α} {λ}^{T} {ϕϕ}^{T} i ) \frac{\hat{D} λ}{{λ}^{T} {\hat{D}}^{2} λ}$$

13. The controller of claim 1 wherein the secondary control voltage v_{q} is optimized for maximum efficiency of balanced motors through solving the constrained linear programming:
$$\begin{matrix}minimum & {p}^{{}^{*} T} {v}_{q} \\ subject to & {[ \begin{matrix}1 & {λ}^{′}\end{matrix} ]}^{T} {v}_{q} = 0 \\ & {v}_{lb} \leq {v}_{q} \leq {v}_{ub}\end{matrix}$$

14. The controller of claim 13 wherein the optimal value of the costate vector p*ₖ at epoch tₖ is estimated from
p*ₖ=(I+σωₖΛₖ^{T})⁻¹iₖ

15. The controller of claim 1 wherein the primary control voltage vₚ to achieve accurate torque production of balanced motors is obtained from the following nonlinear feedback
$${v}_{p} = λω + R ( u - μω {i}^{T} {λ}_{θ} ) \frac{{λ}^{′}}{{‖ {λ}^{′} ‖}^{2}}$$

16. A method of controlling a multi-phase permanent magnet synchronous motor, to enable operation of the motor even if one or more phases are open-circuited, the method comprising:
generating a primary control voltage using a feedback linearization control module;
generating a secondary control voltage using an energy minimizer;
wherein the wherein the primary and secondary control voltage are an orthogonal decomposition of a phase voltage vector to thereby decouple the feedback linearization control module from the energy minimizer such that the energy minimizer does not affect the feedback linearization control module.

17. The method of claim 10 wherein generating the secondary control voltage comprises generating a perpendicular secondary control voltage vector that is perpendicular to a projected version of a vector of a flux linkage derivative.

18. The method of claim 10 wherein generating the secondary control voltage using the energy minimizer comprises estimating a costate and performing constrained linear programming.

19. The method of claim 10 wherein generating the primary control voltage using the feedback linearization control module comprises:
receiving feedback from measured phase currents, motor shaft angle, motor speed, and instantaneous values of a reference torque and a signature vector indicating which phase is open-circuited; and
generating the primary control voltage for a pulse width modulated inverter associated with the motor to establish a first-order linear dynamics relationship between reference and generated torques to thereby control the motor.

20. The method of claim 11 wherein estimating the costate comprises computing costate variables relating to a state of the energy minimizer based on feedback signals including measured phase currents, motor shaft angle, motor speed, and instantaneous values of a reference torque and a signature vector.

21. The method of claim 14 wherein generating the secondary phase voltage using the energy minimizer comprises aligning the secondary phase voltage with a projected version of an estimated costate vector to maximize efficiency.

22. The method of claim 15 wherein generating the secondary control voltage v_{q} comprises constraining the secondary control voltage v_{q} by v_{lb}≦v_{q}≦v_{ub} to avoid saturation where lower-bound voltage v_{lb} and upper-bound voltage v_{ub} are obtained from values of a maximum inverter voltage and an instantaneous primary voltage control.

23. The method of claim 16 wherein generating the secondary control voltage v_{q} is subject to a consistency constraint λ′^{T}\hat{D}v_{q}=0 for unbalanced motors with open-circuited phase(s) such that the energy minimizer does not affect the linearization control module.

24. The method of claim 16 wherein the secondary control voltage v_{q} is subject to a consistency constraint [1 λ′]^{T}v_{q}=0, for balanced motors such that there is no need for a neutral line point such that the energy minimizer does not affect the linearization control module.

25. The method of claim 16 wherein the secondary control voltage v_{q} is optimized for maximum efficiency of unbalanced motors with open-circuited motors by solving constrained linear programming:
$$\begin{matrix}minimum & {p}^{{}^{*} T} \hat{D} {v}_{q} \\ subject to & {λ}^{T} \hat{D} {v}_{q} = 0 \\ & {v}_{lb} \leq {v}_{q} \leq {v}_{ub}\end{matrix}$$

26. The method of claim 25 wherein the optimal value of the costate vector p*ₖ at epoch tₖ is estimated from
$${p}_{k}^{*} = {( I + h {ω}_{k} {Λ}_{k} + \frac{h}{μ} {Γ}_{k} )}^{- 1} {i}_{k}$$

27. The method of claim 16 wherein the primary control voltage vₚ to achieve accurate torque production of unbalanced motors with open-circuited motors is obtained from the following nonlinear feedback
$${v}_{p} = ωλ + R ( u - {μωλ}_{θ}^{T} i - \hat{α} {λ}^{T} {ϕϕ}^{T} i ) \frac{\hat{D} λ}{{λ}^{T} {\hat{D}}^{2} λ}$$

28. The method of claim 16 wherein the secondary control voltage v_{q} is optimized for maximum efficiency of balanced motors through solving the constrained linear programming:
$$\begin{matrix}minimum & {p}^{{}^{*} T} {v}_{q} \\ subject to & {[ \begin{matrix}1 & {λ}^{′}\end{matrix} ]}^{T} {v}_{q} = 0 \\ & {v}_{lb} \leq {v}_{q} \leq {v}_{ub}\end{matrix}$$

29. The method of claim 28 wherein the optimal value of the costate vector p*ₖ at epoch tₖ is estimated from
p*ₖ=(I+σωₖΛₖ^{T})⁻¹iₖ

30. The method of claim 16 wherein the primary control voltage vₚ to achieve accurate torque production of balanced motors is obtained from the following nonlinear feedback
$${v}_{p} = λω + R ( u - μω {i}^{T} {λ}_{θ} ) \frac{{λ}^{′}}{{‖ {λ}^{′} ‖}^{2}}$$

31. A fault-tolerant, energy-efficient motor system comprising:
a multi-phase permanent magnet synchronous motor; and
a controller for controlling the motor, the controller comprising:
a feedback linearization control module for generating a primary control voltage; and
an energy minimizer for generating a secondary control voltage;
wherein the feedback linearization control module is decoupled from the energy minimizer such that the energy minimizer does not affect the feedback linearization control module.

32. The system of claim 31 wherein the secondary control voltage defines a secondary control voltage vector that is perpendicular to a projected version of a flux linkage derivative vector.

33. The system of claim 31 wherein the energy minimizer comprises a constrained linear programming module and a costate estimator.

34. The system of claim 31 wherein the feedback linearization control module receives feedback from measured phase currents, motor shaft angle, motor speed, and instantaneous values of a reference torque and a signature vector indicating which phase is open-circuited and then generates the primary control voltage for a pulse width modulated inverter associated with the motor to establish a first-order linear dynamics relationship between reference and generated torques to thereby control the motor.

35. The system of claim 32 wherein the costate estimator computes costate variables relating to a state of the energy minimizer based on feedback signals including measured phase currents, motor shaft angle, motor speed, and instantaneous values of a reference torque and a signature vector.

36. The system of claim 35 wherein the energy minimizer determines the secondary phase voltage by aligning the secondary phase voltage with a projected version of an estimated costate vector to maximize efficiency.

37. The system of claim 36 wherein the secondary control voltage v_{q} is constrained by v_{lb}≦v_{q}≦v_{ub} to avoid saturation where lower-bound voltage v_{lb} and upper-bound voltage v_{ub} are obtained from values of a maximum inverter voltage and an instantaneous primary voltage control.

38. The system of claim 37 wherein the secondary control voltage v_{q} is subject to a consistency constraint λ′^{T}\hat{D}v_{q}=0 for unbalanced motors with open-circuited phase(s) such that the energy minimizer does not affect the linearization control module.

39. The system of claim 37 wherein the secondary control voltage v_{q} is subject to a consistency constraint [1 λ′]^{T}v_{q}=0, for balanced motors such that there is no need for a neutral line point such that the energy minimizer does not affect the linearization control module.

40. The system of claim 31 wherein the secondary control voltage v_{q} is optimized for maximum efficiency of unbalanced motors with open-circuited motors by solving constrained linear programming:
$$\begin{matrix}minimum & {p}^{{}^{*} T} \hat{D} {v}_{q} \\ subject to & {λ}^{T} \hat{D} {v}_{q} = 0 \\ & {v}_{lb} \leq {v}_{q} \leq {v}_{ub}\end{matrix}$$

41. The system of claim 40 wherein the optimal value of the costate vector p*ₖ at epoch tₖ is estimated from
$${p}_{k}^{*} = {( I + h {ω}_{k} {Λ}_{k} + \frac{h}{μ} {Γ}_{k} )}^{- 1} {i}_{k}$$

42. The system of claim 41 wherein the primary control voltage vₚ to achieve accurate torque production of unbalanced motors with open-circuited motors is obtained from the following nonlinear feedback
$${v}_{p} = ωλ + R ( u - {μωλ}_{θ}^{T} i - \hat{α} {λ}^{T} {ϕϕ}^{T} i ) \frac{\hat{D} λ}{{λ}^{T} {\hat{D}}^{2} λ}$$

43. The system of claim 41 wherein the secondary control voltage v_{q} is optimized for maximum efficiency of balanced motors through solving the constrained linear programming:
$$\begin{matrix}minimum & {p}^{{}^{*} T} {v}_{q} \\ subject to & {[ \begin{matrix}1 & {λ}^{′}\end{matrix} ]}^{T} {v}_{q} = 0 \\ & {v}_{lb} \leq {v}_{q} \leq {v}_{ub}\end{matrix}$$

44. The system of claim 43 wherein the optimal value of the costate vector p*ₖ at epoch tₖ is estimated from
p*ₖ=(I+σωₖΛₖ^{T})⁻¹iₖ

45. The system of claim 41 wherein the primary control voltage vₚ to achieve accurate torque production of balanced motors is obtained from the following nonlinear feedback
$${v}_{p} = λω + R ( u - μω {i}^{T} {λ}_{θ} ) \frac{{λ}^{′}}{{‖ {λ}^{′} ‖}^{2}}$$

46. A controller for controlling a salient-pole synchronous motor, the controller comprising:
a voltage computational module for computing a dq voltage based at least on shaft position and speed, and phase current;
an energy minimizer module for computing an energy minimizing control input z; and
a voltage computational module for computing a dq voltage based in part on a torque command input component u and said energy minimizing control input z.

47. A controller according to claim 46, wherein said torque command input component is limited in magnitude according to at least a maximum inverter voltage limit vₘₐₓ.

48. A controller according to claim 46, wherein said controller is further adapted to compute inverter phase voltages as the said torque command input u to said salient-pole synchronous motor.
